(19) United States
(12) Patent Application Publication
(10) Pub. No.: US 2018/0155614 A1
(43) Pub. Date: Jun. 7, 2018

(54) SELF-SUSPENDING PROPPANTS

(71) Applicant: SELF-SUSPENDING PROPPANT LLC, Chesterland, OH (US)

(72) Inventors: David S. Soane, Chestnut Hill, MA (US); Moustafa Aboushabana, Stafford, TX (US); James Nathan Ashcraft, Jupiter, FL (US); Allison Silverstone, Hillsboro Beach, FL (US); Kanth Josyula, Sugar Land, TX (US); Huaxiang Yang, Sugar Land, TX (US); An Thien Nguyen, Sugar Land, TX (US); Vinay Mehta, Richmond, TX (US)

(21) Appl. No.: 15/782,066

(22) Filed: Oct. 12, 2017

Related U.S. Application Data
(60) Provisional application No. 62/407,611, filed on Oct. 13, 2016.
(60) Provisional application No. 62/428,258, filed on Nov. 30, 2016.

(51) Int. Cl. C09K 8/80; C09K 8/68; E21B 43/267

(52) U.S. Cl. CPC C09K 8/805; E21B 43/267; C09K 8/685

(57) ABSTRACT

A self-suspending proppant comprises a proppant substrate particle and a water-swellable composite coating on the proppant substrate particle comprising the combination of at least two of an anionic hydrogel polymer, a cationic hydrogel polymer and a nonionic hydrogel polymer.

### RELATED APPLICATIONS

This application claims priority to provisional application, U.S. Ser. No. 62/407,611, filed Oct. 13, 2016, entitled Amphoteric Self-Suspending Proppants by Moustafa Aboushabana, et al., (Attorney Docket No. 17922/05187) and to U.S. Ser. No. 62/428,258, filed Nov. 30, 2016, entitled Self-Suspending Proppants by David S. Soane et al. The contents of both applications are incorporated herein by reference in their entireties.

### BACKGROUND

In commonly assigned U.S. Pat. No. 9,297,244 (7-US) and U.S. Pat. No. 9,315,721 (4-US), there are described self-suspending proppants which take the form of a proppant substrate particle carrying a coating of a hydrogel-forming polymer. As further described there, these proppants are formulated in such a way that they rapidly swell when contacted with aqueous fracturing fluids to form hydrogel coatings which are large enough to significantly increase the buoyancy of these proppants during their transport downhole yet durable enough to remain largely intact until they reach their ultimate use locations. The disclosures of all of these earlier applications are incorporated herein by reference in their entireties.

It is well known that calcium and other cations can substantially retard the ability of anionic hydrogel-forming polymers to swell. This problem can be particularly troublesome when self-suspending proppants made with such polymers are used, because the waters to which the proppants are exposed, including both the source water from which the associated fracturing fluid is made up as well as the geological formation water which the proppants encounter downhole, can often contain significant quantities of these ions.

This problem, i.e., the tendency of calcium and other cations to retard the ability of anionic hydrogel-forming polymers to swell, can begin to occur when the hardness of the water encountered by the polymer reaches levels as low as 300 ppm. In the context of this document, the “hardness” of a water sample means the sum of the concentrations of all divalent cations in the sample in terms of an equivalent weight of calcium carbonate. For example, a hardness of 1,000 ppm means that the total concentration of divalent cations in the sample is the same as the concentration of calcium cations that would be produced by 1,000 ppm by weight of CaCO₃ dissolved in pure water.

In many places in the United States especially where hydraulic fracturing may be practiced, municipal waters (i.e., the potable water produced by local municipalities) can have hardness levels of 300 ppm or more, while naturally-occurring ground waters can have hardness levels of 1,000 ppm or more. Meanwhile, sea water has a hardness of approximately 6,400 ppm, while the geological formation waters encountered downhole in many locations where hydraulic fracturing occurs can have hardness levels even as high as 40,000 ppm or even 80,000 ppm. That being the case, the performance advantages of self-suspending proppants made with anionic hydrogel-forming polymers can be adversely affected as the hardness of the water to which the proppant is exposed increases.

### BRIEF DESCRIPTION OF THE DRAWINGS

FIGS. 1-5 are photographs showing the settled bed heights of some of the modified proppants described in Examples 3-5 of this disclosure.

### SUMMARY

We have now found that especially desirable salt-tolerant self-suspending proppants can be made by forming the water-swellable coating of the proppant from the combination of two or more of an anionic hydrogel polymer, a cationic hydrogel polymer and a nonionic hydrogel polymer.

Thus, this invention provides a self-suspending proppant comprising a proppant substrate particle and a water-swellable composite coating on the proppant substrate particle, wherein the water-swellable composite coating comprises the combination of two or more of an anionic hydrogel polymer, a cationic hydrogel polymer and a nonionic hydrogel polymer.

In addition, this invention also provides an aqueous fracturing fluid comprising an aqueous carrier liquid containing the above self-suspending proppant.

In addition, this invention further provides a method for fracturing a geological formation comprising pumping this fracturing fluid into the formation.

### DETAILED DESCRIPTION

### Proppant Substrate Particle

As indicated above, the inventive self-suspending proppants take the form of a proppant substrate particle carrying a water-swellable composite coating. The substrate particle is referred to herein as a particulate solid, substrate, proppant, particulate material, proppant substrate particle, and particulate, for example. These terms, in the context of referring to the substrate, are intended to be interchangeable.

For this purpose, any particulate solid which has previously been used or may be used in the future as a proppant in connection with the recovery of oil, natural gas and/or natural gas liquids from geological formations can be used. In this regard, see our earlier filed application mentioned above and International Patent Application No.: PCT/US13/32435, filed Mar. 15, 2013, entitled Self-Suspending Proppants for Hydraulic Fracturing by Mahoney et al., incorporated herein by reference, which identify many different particulate materials which can be used for this purpose. These materials can have densities as low as ˜1.2 g/cc and as high as ˜5 g/cc and even higher, although the densities of the vast majority will range between ˜1.8 g/cc and ˜5 g/cc, such as for example ˜2.3 to ˜3.5 g/cc, ˜3.6 to ˜4.6 g/cc, and ˜4.7 g/cc and more.

Specific examples include graded sand, bauxite, ceramic materials, glass materials, polymeric materials, resinous materials, rubber materials, nutshells that have been chipped, ground, pulverized or crushed to a suitable size (e.g., walnut, pecan, coconut, almond, ivory nut, brazil nut, and the like), seed shells or fruit pits that have been chipped, ground, pulverized or crushed to a suitable size (e.g., plum, olive, peach, cherry, apricot, etc.), chipped, ground, pulverized or crushed materials from other plants such as corn cobs, composites formed from a binder and a filler material such as solid glass, glass microspheres, fly ash, silica, alumina, fumed carbon, carbon black, graphite, mica, boron, zirconia, talc, kaolin, titanium dioxide, calcium silicate, and the like, as well as combinations of these different materials. Especially interesting are intermediate density ceramics (densities ˜3.1-3.5 g/cc), normal frac sand, or frac sand, (density ˜2.65 g/cc), bauxite and high density ceramics (density ˜3.5-5 g/cc), just to name a few. Preferably, the material, or substrate, possesses sufficient compression strength to withstand the pressure within the geological formation, such as the compression strength of frac sand.

In addition to these materials, resin coated varieties of these materials can also be used. Specific examples include resin coated sand, including sands coated with curable resins as well as sands coated with precured resins. Other specific examples include resin coated ceramic materials (light weight, intermediate density and high density ceramics), including ceramics coated with curable resins as well as ceramic coated with precured resins. In these instances, the water-swellable coating of the inventive self-suspending proppant will be understood to be “associated with” the proppant substrate particle of this product rather than being “on” this substrate particle. In other embodiments, the water-swellable coating will provide a second coating, or outer layer over, the resin.

As used herein, the term “particulate” includes, for example, spherical materials, elongate materials, polygonal materials, fibrous materials, irregular materials, and any mixture thereof.

All of these substrates or particulate materials, as well as any other particulate material which is used as a proppant in the future, can be used to make the inventive self-suspending proppants.

### Water-Swellable Composite Coating

As indicated above, the inventive self-suspending proppants are made in such a way that:
(1) optionally and preferably, they are free-flowing when dry,
(2) they rapidly swell when contacted with their aqueous fracturing fluids,
(3) they form hydrogel coatings which are large enough to significantly increase their buoyancy during transport downhole, thereby making these proppants self-suspending during this period,
(4) optionally and preferably, these hydrogel coatings are durable enough to maintain the self-suspending character of these proppants until they reach their final destination downhole, and
(5) these hydrogel coatings are especially resistant to the adverse effects calcium and other cations can have on the swelling properties of these coatings.

In accordance with this invention, this is accomplished by forming the water-swellable composite coating of the inventive self-suspending proppant from the combination of two or more of an anionic hydrogel polymer, a cationic hydrogel polymer and a nonionic hydrogel polymer.

The polymers can be added to the substrate independently, as a mixture, simultaneously or sequentially.

For example, in some embodiments, these hydrogel polymers can be combined with one another before they are added to the proppant substrate particles. In these embodiments, the water-swellable composite coating can be regarded as being formed from a mixture of these hydrogel polymers. Depending on how much these polymers are mixed before being added to the proppant substrate particles, the distribution of these polymers in the coating that is formed can be either homogeneous or non-homogeneous. For example, the polymers can be added to a single aqueous solution, optionally emulsified in an inverse emulsion, and then added to the substrate for coating. Alternatively, a plurality of inverse emulsions each comprising at least one water-swellable polymer can be mixed and then added to the substrate.

In other embodiments, these hydrogel polymers (e.g., in an aqueous solution, suspension or emulsion) can be separately combined with the proppant substrate particles at the same time. That is to say, they can be supplied to the manufacturing equipment in which the water-swellable composite coating is formed from separate sources but at the same time. In these embodiments, the water-swellable composite coating can exhibit either a homogeneous or non-homogeneous distribution of these hydrogel polymers depending, for example, on the extent they mix as they deposit on the proppant substrate particles.

In still other embodiments, these hydrogel polymers can be separately combined with the proppant substrate particles at different times, or sequentially. In these situations, the proppant substrate particles will be at least partially coated with the first-applied hydrogel polymer to form an undercoating, after which an overcoating, or outer layer, formed from the second-applied hydrogel polymer would be formed on this undercoating.

This overcoating approach can be carried out in two or more different ways. In one way, formation of the overcoating is not started until formation of the undercoating has been completed. This can be done, for example, by drying the undercoating before starting to form the overcoating or at least by allowing essentially all of the hydrogel polymer forming the undercoating to deposit on the proppant substrate particles before adding the hydrogel polymer forming the overcoating. In this instance, the water-swellable composite coating can, or may, be regarded as comprising two or more distinct coating layers, an undercoating made from the first-applied hydrogel polymer and an overcoating made from the second-applied hydrogel polymer.

Another way this overcoating approach can be done is by starting to form the overcoating before formation of the undercoating is complete. In this instance, the water-swellable composite coating will, or may, not be composed of two or more distinct coating layers. Rather, it will, or may, be composed of a mixture of the first-applied and second-applied hydrogel polymers distributed in the composite coating in a non-uniform way, in particular, with the concentration of the first-applied hydrogel polymer decreasing and the concentration of the second-applied hydrogel polymer increasing as the distance away from the surface of the proppant substrate particle increases. In this embodiment, one or more of the polymers may be present in the water-swellable coating in a gradient.

Instead of forming the water-swellable composite coating of the inventive self-suspending proppant from two coating layers in the manner discussed above, it can also be formed from three or more coating layers, e.g., one being made from the anionic hydrogel polymer, another being made from the cationic hydrogel polymer and the third being made from the nonionic hydrogel polymer. If so, these three different hydrogel polymer layers can be arranged in any order with respect to one another. The layers may be distinct layers or may form one or more gradients, as discussed above. In a preferred embodiment, the outermost coating layer will be formed from the cationic or nonionic hydrogel polymer, and especially the cationic hydrogel polymer. Preferably, the anionic hydrogel polymer will be localized in an inner layer, or concentrated or localized on the surface of the substrate.

Also, in the same way as discussed above in connection with two-layer water-soluble composite coatings when three-layer water-soluble composite coatings are made, formation of the intermediate and outer coating layers can begin before formation of the preceding layer is complete so that the water-soluble composite coating obtained, rather than being formed from three distinct coating layers, is formed from a mixture of the first-applied, second-applied and third-applied hydrogel polymers distributed in the composite coating in a non-uniform way, in particular, with the concentration of the previously-applied hydrogel polymer decreasing and the concentration of the subsequently-applied hydrogel polymer increasing as the distance away from the surface of the proppant substrate particle increases.

Another way water-swellable composite coatings of the inventive self-suspending proppants can be made using all three of an anionic hydrogel polymer, a cationic hydrogel polymer and a nonionic hydrogel polymer is to make a two-layer water-soluble composite coating with one or both of these layers being composed a homogeneous or non-homogeneous mixture of two of these hydrogel polymers but not the third. For example, the water-swellable coating can be composed of an undercoating comprising an anionic hydrogel polymer such as an anionic polyacrylamide and an overcoating comprising the combination of a cationic hydrogel polymer and a nonionic hydrogel polymer.

Yet another way water-swellable composite coatings of the inventive self-suspending proppants can be made from all three of an anionic hydrogel polymer, a cationic hydrogel polymer and a nonionic hydrogel polymer is to make this water-swellable composite coating from a homogeneous or non-homogeneous mixture of all three of these hydrogel polymers.

Generally, the water-soluble composite coating of the inventive self-suspending proppants will be composed of either one, two or three coating layers, as discussed above, it being understood that when two or three coating layers are involved these different coating layers can either be distinct or non-distinct in the sense that the hydrogel polymers forming these different layers are distributed in the water-swellable composite coating in a non-uniform way.

However, it is also possible in accordance with this invention that additional coating layers can be included in the inventive self-suspending proppants, with these additional coating layers being located underneath, on top of, or in between coating layers forming this water-soluble composite coating. In most instances, however, the inventive self-suspending proppant will be structured so that the outermost coating layer of the proppant comprises a cationic hydrogel polymer, a non-ionic hydrogel polymer, or a mixture of both. Inventive self-suspending proppant in which the outermost coating layer of the proppant comprises a cationic starch, a pre-crosslinked cold water-swellable starch, or a mixture of both, are especially interesting.

### Anionic Hydrogel Polymer

The anionic hydrogel polymers which can be used to form the water-swellable composite coating of the inventive self-suspending proppant include any polymer which is capable of forming a hydrogel when exposed to water and which, in addition, exhibits anionic functionality can be used. Mixtures of these polymers can also be used. Basically, these polymers take the form of a polymer or copolymer which is capable of forming a hydrogel and which has been made from a monomer or comonomer which exhibits anionic functionality, or which is treated after it is made to impart anionic functionality, or both.

Examples of synthetic polymers, which are capable of forming hydrogels, include polymers and copolymers of acrylamide, polymers and copolymers of acrylic acid and its salts, polyvinylalcohols, polyurethanes, polyethylene glycols, polypropylene glycols, betaine esters, amino acid-based poly(ester amides) (AA-PEAs) and polysiloxanes.

Examples of naturally occurring polymers, which are capable of forming hydrogels, are various polysaccharides such as starches including modified starches such as acid-modified starches, alkylated starches, oxidized starches, acetylated starches, dextrans, dextrins, and so forth. Natural gum polymers such as guar gum, carboxymethyl guar and carboxymethyl hydroxypropyl guar gum can also be used, as can cellulose based polymers such as cellulose and cellulose derivatives including alkyl cellulose ethers such as methyl cellulose, ethyl cellulose and/or propyl cellulose, hydroxy cellulose ethers such as hydroxy methyl cellulose, hydroxy ethyl cellulose, carboxymethyl cellulose, and/or hydroxy propyl cellulose, cellulose esters such as cellulose acetate, cellulose triacetate, cellulose propionate and/or cellulose butyrate, cellulose nitrate and cellulose sulfate. Also useful are chitosan, glycogen and biopolymers such as proteins, protein hydrolysates, and the like. Mixtures of these materials can also be used.

Examples of moieties which can be included in such polymers for exhibiting anionic functionality include carboxyl groups, metal carboxylate groups especially those in which the metal is an alkaline or alkaline earth metal, sulfonates and phosphates.

Any polymer which is capable of forming a hydrogel when exposed to water and which, in addition, exhibits anionic functionality can be used for carrying out this invention. They are well known and described, for example, in commonly assigned U.S. Pat. No. 9,297,244 (7-US) and U.S. Pat. No. 9,315,721 (4-US), the disclosures of which are incorporated herein by reference. Generally, these polymers will have weight average molecular weights on the order of 1,000,000 to 60,000,000 Daltons, more typically, 5,000,000 to 40,000,000 Daltons or even 10,000,000 to 30,000,000 Daltons, and charge densities (or degrees of hydrolysis) of 5 to 90 mole %, more typically, 10 to 60 mole %, 15 to 50 mole %, or even 20 to 40 mole %. In this context, “charge density” will be understood to mean the net negative charge imparted by the anionic group expressed as mole %, i.e., the mole % of monomers in the polymer which exhibit anionic functionality.

Anionic hydrogel polymers of special interest are the anionic polyacrylamides. An example of such an anionic polyacrylamide is given by the following formula:

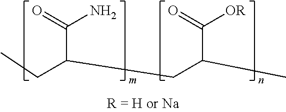

wherein
m is the molar fraction of acrylamide in the copolymer and ranges from 0.05 to 0.9, more typically 0.2 to 0.6, 0.15 to 0.50, or even 0.2 to 0.4,
n is the molar fraction of anionic comonomer in the copolymer, and
0.9≤(m+n)≤1. Generally, (m+n) will be at least 0.95, at least 0.98, or even 1.
R may also be other monovalent substituents, especially alkali metal.

Polymethacrylamides are also contemplated. In an especially interesting embodiment of this invention, the anionic hydrogel polymer is a hydrolyzed polyacrylamide. Generally speaking, there are two primary ways of making the above anionic polyacrylamide commercially, (1) copolymerizing acrylamide with a comonomer exhibiting anionic functionality such as acrylic acid or sodium acrylate and (2) hydrolyzing a polyacrylamide homopolymer by contact with a strong acid or base. In accordance with this invention, it has been found that hydrolyzed polyacrylamides, i.e., anionic polyacrylamides made by hydrolyzing a polyacrylamide homopolymer, especially those made by hydrolyzing with a strong base, produce self-suspending proppants with especially good hard water tolerance.

Although not wishing to be bound to any theory, it is believed that hydrolyzed anionic polyacrylamides exhibit this enhanced hard water tolerance because the pendant carboxylic groups which are produced by hydrolysis are distributed in the polymer chain with a greater degree of non-uniformity (i.e., more randomly) as compared with anionic polyacrylamides made by other techniques. As a result, the ability of the polymer to bind the divalent calcium or magnesium cations in hard water is less, because the number of instances in which two pendant carboxylic groups are directly adjacent one another in the polymer chain is less.

It is believed random distribution of pendant carboxylic groups does not occur to the same extent when other techniques are used to make the anionic polyacrylamides. As a result, the polymer chain of a copolymerized acrylate and acrylamide monomers has more pairs and triads of directly adjacent pendant carboxylic groups which are capable of taking up and binding the divalent calcium and magnesium cations found in hard water. Therefore, when such a polymer is exposed to hard water, more of its pendant carboxylic groups are taken up by binding calcium and magnesium ions which, in turn, reduces the number ofthese pendant carboxylic groups which are available for taking up and “binding” water molecules. Since it is this taking up and binding of water molecules which is responsible for polymer swelling, the net effect of this uniform distribution of pendant carboxylic groups is that the ability of these polymers to swell when exposed to hard water is less. See, Truong et al., Effect of the Carboxylate Group Distribution on the Potentiometric Titration of Acrylamide-Acrylic Acid Copolymers, Polymer Bulletin 24, 101-106 © Springer-Verlag 1990.

As in the case of the other anionic polyacrylamides described above, it is desirable that the hydrolyzed anionic polyacrylamides described here also exhibit a charge density (or degree of hydrolysis) of 5 to 90 mole %, more typically, 10 to 60 mole %, 15 to 50 mole %, or even 20 to 40 mole %.

Preferred anionic polyacrylamides include polyacrylamide inverse emulsions, particularly high molecular weight polyacrylamide inverse emulsions. Preferred polyacrylamides include the FLOPAM series of polyacrylamides, particularly, FLOPAM EM533, from SNF. Such polyacrylamides form interpenetrating networks when contacted with the substrate, optionally crosslinked, dewatered and dried, creating a shear-stable cage surrounding the substrate particles.

### Cationic Hydrogel Polymer Coating

The cationic hydrogel polymers which can be used to form the water-swellable composite coating of the inventive self-suspending proppant include any polymer which is capable of forming a hydrogel when exposed to water and which, in addition, exhibits cationic functionality. Mixtures of these polymers can also be used. Like the anionic hydrogel polymers described above, these polymers also take the form of a polymer or copolymer which is capable of forming a hydrogel. However, in this instance, these polymers have been made from a monomer or comonomer which exhibits cationic functionality, or have been treated after being made to impart cationic functionality, or both.

These polymers can be made from the same hydrogel polymers from which the anionic hydrogel polymers described above are made.

In order to impart cationic functionality to these polymers, any known cationic reagent can be used, examples of which include amino groups, imino groups, sulfonium ions, phosphonium ions, ammonium ions and mixtures thereof. Generally, these polymers will have weight average molecular weights on the order of 1,000,000 to 60,000,000 Daltons, more typically, 5,000,000 to 40,000,000 Daltons or even 10,000,000 to 30,000,000 Daltons, and charge densities 5 to 90 mole %, more typically, 10 to 60 mole %, 15 to 50 mole %, or even 20 to 40 mole %.

Cationic hydrogel polymers of special interest are the cationic starches, such as starches that are at least partially gelatinized in form. Examples of suitable starches which can be used for this purpose include naturally-occurring starches, acid-modified starches, pre-crosslinked starches, alkylated starches, oxidized starches, acetylated starches, hydroxypropylated starches, monophosphorylated starches, octenylscuccinylated starches and so forth.

Starches can be anionic, cationic and amphoteric, depending primarily on the nature of the substituents present at the 2, 3, 5 and 6 positions of the monosaccharide units forming the starch molecule. In accordance with this embodiment of the invention, cationic starches are used to make the cationic hydrogel coatings of the inventive self-suspending proppants, especially those cationic starches which have a degree of substitution (i.e., cationic degree of substitution) of 0.017 to 0.55 or higher. Those cationic starches having a degree of substitution of 0.030 to 0.55, 0.15 to 0.45 or even 0.2 to 0.4 are even more interesting. Of these cationic starches, those having from about 1 to 50 wt. %, more typically about 5 to 30 wt. % or even about 10 to 25 wt. % of amylase (linear polymer) units and about 50 to 99 wt. %, more typically about 70 to 95 wt. % or even about 75 to 90 wt. % of amylopectin (branched polymer) are especially interesting. Also especially interesting are those cationic starches whose cationic functionality is based on quaternary ammonium groups.

Those of the above cationic starches having both a high degree of substitution as represented by a degree of substitution of at least about 0.04, preferably at least about 0.1, and a low amylase content, i.e., 10 wt. % or lower, are especially interesting.

Cationic starches which are useful in this invention also typically have molecular weights of about 1 to 8 million Daltons, more typically about 2 to 6 million Daltons, although higher and lower molecular weights are still possible.

A wide variety of different commercially available cationic starches can be used for the purposes of this invention. Examples include the ALTRA-CHARGE line of cationic starches available from Cargill, Incorporated of Wayzata, Minn., the STA-LOK and INTERBOND line of cationic starches available from Tate & Lyle of Decatur, Ill., and the CHARGEMASTER line of cationic starches available from Grain Processing Corporation of Muscatine, Iowa They are available in different forms including powders, aqueous pastes, aqueous slurries, aqueous dispersions and aqueous solutions, all of which can be used to make the self-suspending proppants of this invention.

Specific examples include CHARGEMASTER R31F, R32F, R33F, R43F, R25F, R67F, R467, R62F, R63F and R65F, INTERBOND® C, STA-LOK® 120, 156, 160, 180, 182, 190, 300, 310, 330, 356 and 376, and ALTRA CHARGE™ 240 and 340 and others. Specific examples of cationic starches in paste or slurry form that can be used for this purpose include CHARGEMASTER L435, L340 and L360.

In addition to purchasing commercially available cationic starches, these materials can also be made in-house if desired. For example, a starch can be made cationic by reacting it with any known cationic reagent, examples of which include reagents having amino groups, imino groups, sulfonium ions, phosphonium ions, or ammonium ions and mixtures thereof. The cationization reaction may be carried out in any conventional manner such as reacting the starch with the cationic reagent in an aqueous slurry, usually in the presence of an activating agent such as a base like sodium hydroxide. Another process that may be used is a semi-dry process in which the starch is reacted with the cationic reagent in the presence of an activating agent such as a base like sodium hydroxide in a limited amount of water.

Especially interesting cationic reagents that can be used for this purpose are those based on quaternary ammonium compounds in either epoxy or chlorohydrin form. This is because the epoxy and chlorohydrin functionalities of these compounds react quickly with the pendant alcohol groups of the starch polymer while their quaternary ammonium groups provide the cationic functionality to the polymer. Specific examples include (3-chloro-2-hydroxypropyl)trimethylammonium chloride and 2,3-epoxypropyltrimethylammonium chloride. Techniques for preparing cationic starches are well known and described in numerous references. See, for example, U.S. Pat. No. 4,554,021. See, also, QUAB® Cationization of Polymer, Product literature of SKW Quab Chemicals, Inc. of Saddle Brook, N.J., pp 1-11. Also, see, Moad, Chemical Modification of Starch by Reactive Extrusion, Progress in Polymer Science 36 (2011) 218-237. In addition, please also note Properties of Modified Starches and their Use in the Surface Treatment of Paper, Dissertation of Anna Jonhed, 2006:42, at http://www.diva-portal.org/smash/get/diva2:6450/FULLTEXT01.pdf, Karlstad University 2006. The disclosures of each of these references are incorporated herein by reference in their entireties.

As indicated above, the cationic starches which are used to make the water-swellable composite coatings of the inventive self-suspending proppant are at least partially gelatinized. Starch molecules arrange themselves in plants in semi-crystalline granules. Heating in water causes water molecules to diffuse through these granules, causing them to become progressively hydrated and swell. In addition, their amylase content depletes through leaching out by the water. When further heated, these granules “melt” or “destructure” in the sense that their semi-crystalline structure is lost, which can be detected by a variety of different means including X-ray scattering, light-scattering, optical microscopy (birefringence using crossed polarizers), thermomechanical analysis and NMR spectroscopy, for example. This “melting-destructuration” effect is known as gelatinization. See, Kalia & Avernus, Biopolymers: Biomedical and Environmental Applications, p. 89, © 2011 by Scrivener Publishing LLC, Co-published by John Wiley & Sons, Hoboken, N.J.

Incidentally, for convenience, in this disclosure we use the term “gelatinized” and “gelatinous” in connection with starches to refer both to starches which are only partially gelatinized as well as to starches which are fully gelatinized in the sense of being incapable of taking up any more water of gelatinization. In addition, we use the term “dried” in connection with these starches to refer to starches which have undergone this gelatinization procedure and then are subsequently dried, whether gelatinization and drying occur in-house or have already occurred at the manufacturer before purchase.

A convenient way of insuring that the desired degree of starch gelatinization is achieved when using starches that have not been previously gelatinized is to control the water/cationic starch weight ratio of the water/starch coating composition which is used to make the inventive self-suspending proppants. Generally, this ratio can range from about 0.05:1 to 15:1, although water/starch weight ratios of 0.5:1 to 10:1, 0.75:1 to 7.5:1, 1:1 to 5:1, 1.25:1 to 4:1, and even 1.5:1 to 3:1, are contemplated. And for this calculation, it will be understood that all of the water present in this coating composition will be taken into account including the moisture/water content of the raw material cationic starch used, any water that might be present from applying the other water-swellable coating layer, any make-up water that might be added, and the water content of any ingredient that might be used such as crosslinking agents and the like.

Starch gelatinization generally requires that the starch-water combination have a slightly alkaline pH such as ≥7.5, ≥8, ≥9, and even ≥10 as well that the starch-water combination be heated to above a characteristic temperature, known as the gelatinization temperature. See, the above-noted Kalia publication. So, in carrying out this embodiment of the invention, heating of the cationic starch under suitable conditions to achieve at least partial starch gelatinization may be necessary, if the raw material starch that is being used has not been previously gelatinized.

In addition to using the above cationic starches, copolymers or block polymers of these cationic or even neutral starches with other vinyl comonomers or polymers can also be used. Examples include acrylamides, acrylates, methacrylates, 2-acrylamido-2-methylpropanesulfonic acid (AMPS), vinyl acetate, vinyl alcohol and so forth. Desirably, these cationic starch copolymers have the same degree of substitution mentioned above. That is, the degree of substitution provided by the cationic functionality of these copolymers is the same as mentioned above.

Techniques for forming water-swellable coating layers made from at least partially gelatinized cationic starches on proppants substrate particles are more fully described in the above-mentioned commonly-assigned application U.S. Ser. No. 62/337,547 (17922/05168), the disclosure of which is incorporated herein by reference in its entirety.

Another type of cationic hydrogel-forming polymer of special interest in connection with making the water-swellable composite coating of the inventive self-suspending proppant are the cationic polyacrylamides. These polymers are copolymers of acrylamide and one or more additional comonomers capable of introducing cationic functionality into the polymer. They also may be chemically modified polyacrylamides made by introducing one or more cationic moieties. This cationic functionality can be based on a variety of different pendant cationic groups including quaternary ammonium compounds, phosphonium salts and sulphonium salts. Such cationic polyacrylamides typically have weight average molecular weights on the order of 100,000 to 60,000,000 Daltons, more typically, 500,000 to 40,000,000 Daltons or even 10,000,000 to 30,000,000 Daltons, and charge densities of 5 to 85 mole %, more typically, 10 to 80 mole % or even 15 to 70 mole %.

An example of such a cationic polyacrylamide is given by the following formula:

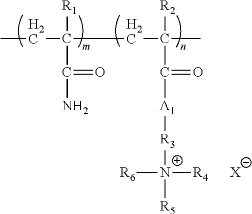

wherein
m is the molar fraction of acrylamide or methacrylamide in the copolymer,
n is the molar fraction of cationic comonomer in the copolymer,
m and n are each independently within the range of from 0 to 1,
(m+n)≤1,
R₁ is hydrogen or methyl,
R₂ is hydrogen or methyl,
A₁ is —O— or —NH—,
R₃ is alkylene having from 1 to 3 carbon atoms or hydroxypropylene,
R₄, R₅ and R₆ are each independently methyl or ethyl or other alkyl having from 3 to 12 carbon atoms, and
X is an anionic counter ion, such as, for example, chloride, bromide, methyl sulfate, ethyl sulfate or the like.
   Note that, when A₁ is —NH—, it can be considered as chemically modified polyacrylamide rather than a copolymer theoretically.

In a particular polyacrylamide of this type, the molar ratio of acrylamide (m) to cationic monomer (n) is in the range of 0:1 to 0.95:0.05, while the sum of the molar ratios of m and n is 1. The cationic polyacrylamides of the above formula can be random or block copolymers.

### Nonionic Hydrogel Polymer Coating

The nonionic hydrogel polymers which can be used to form the water-swellable composite coating of the inventive self-suspending proppant include any polymer which is capable of forming a hydrogel when exposed to water and which, in addition, exhibits little or no anionic or cationic functionality can be used. Mixtures of these polymers can also be used.

These polymers can be made from the same hydrogel polymers from which the anionic and cationic hydrogel polymers described above are made.

Of these nonionic hydrogel polymers, those which are cold water-swellable are of interest. In this context, “cold water-swellable” means that the polymer will form a relatively homogeneous hydrogel mass in room temperature water with gentle mixing. These hydrogel polymers are interesting because they can be directly used in powder form, as received from the manufacturer. That is to say, they can be added to the other ingredients forming the water-swellable composite coating without dilution in a carrier liquid first. On the other hand, they can also be dissolved or dispersed in a suitable carrier liquid such as water, isopropyl alcohol or various organic solvents such as mineral oils, various alkanes such as n-hexane, various commercially available isoparaffinic solvents, and the like before being added to these other ingredients.

In addition to cold water-swellable nonionic hydrogel polymers, pre-crosslinked nonionic hydrogel polymers are also interesting. Nonionic hydrogel polymers which are both cold water-swellable and pre-crosslinked are even more interesting.

Especially interesting nonionic hydrogel polymers are the pre-crosslinked, cold water-swellable starches. Examples include hydroxypropylated di-starch phosphate (HDP), which is commercially available from Cargill as HiForm 12750. Other examples include PolarTex Inst 12640 and StabiTex Inst 12620 also available from Cargill.

Additionally or alternatively, the anionic polymer, cationic polymer and/or nonionic polymer can be covalently linked, as can be found in a block polymer. Additionally and/or alternatively, the anionic, cationic and/or nonionic polymers can be water-soluble and subsequently crosslinked to render them water-swellable. Thus, aqueous polymer solutions and/or inverse emulsions are added to the substrate and then crosslinked, as discussed in more detail below.

In an especially interesting embodiment of this invention, the inventive self-suspending proppants are made by a continuous process in which an anionic polymer in a suitable carrier liquid, such as water or an inverse emulsion, is added to the proppant substrate particles first, following which the remaining polymers are added while the anionic hydrogel polymer is still wet with its carrier liquid. Mixing is then continued until the hydrogel polymers have deposited onto the proppant substrate particles, after which the coated product so formed is dried.

In this continuous process, these remaining hydrogel polymers can also be supplied in their own carrier liquids, such as water or an inverse emulsion, if desired. However, in those embodiments in which the remaining hydrogel polymers include a cold water-swellable nonionic hydrogel polymer, this hydrogel polymer can be added to the previously formed mixture of anionic hydrogel polymer and proppant substrate particles in powder form without dilution in its own carrier liquid, since it will readily disperse in and gel when contacted with the aqueous carrier liquid of the anionic hydrogel polymer. Pre-crosslinked cold water-swellable neutral starches work especially well for this purpose.

### Coating Amounts

The total amount of hydrogel polymers used to make the water-swellable composite coating of inventive self-suspending proppants depends among other things on the degree or extent to which it is desired to increase the buoyancy of these proppants. One way this enhanced buoyancy can be quantified is by comparing the thickness of the water-swellable composite coating that is formed after it has expanded through contact with an excess of water with the average diameter of the proppant particle substrate.

Another way this enhanced buoyancy can be quantified is by determining the settled bed height of the inventive self-suspending proppant when fully expanded with water with the settled bed height of an equivalent amount of uncoated proppant substrate particles.

Still another way this enhanced buoyancy can be quantified is by comparing the density of the inventive self-suspending proppant when fully expanded with water to the density of the proppant substrate particle from which it is made. For example, normal frac sand has a density (e.g., an apparent specific gravity) of −2.65 g/cc, whereas a self-suspending proppant made in accordance with this invention from this substrate particle can have a density of about 1.5 g/cc when fully expanded, for example. This means that the water-swellable composite coating of this invention has been able to decrease the effective density of this self-suspending proppant by about 1.15 g/cc or by about 40% or more, approximating the density of the aqueous fracturing fluid.

In carrying out this invention, the relative amounts of the water-swellable composite coating and proppant substrate particles used can vary widely, and essentially any amounts can be used. In some embodiments, the amount used will be sufficient so that the thickness of the water-swellable composite coating which is formed when fully expanded with water is 10% to 1000% of the average diameter of the proppant particle substrate. Water-swellable composite coating thicknesses of 25% to 750%, 50% to 500% and 100% to 300% of the average diameter of the proppant particle substrate are contemplated.

Additionally or alternatively, the amount of water-swellable composite coating used will be sufficient so that the Settled Bed Height of the product, as can be determined in the manner discussed more fully below, is at least 130%, more desirably, at least 150%, at least 175%, at least 200%, at least 250%, at least 300%, at least 350% and even at least 400% of the Settled Bed Height of an equivalent amount of uncoated proppant substrate particles.

Additionally or alternatively, the amount of water-swellable composite coating used will be sufficient so that a decrease in density of at least about 0.25 g/cc, determined as described above, is achieved. More typically, the decrease in density will be at least about 0.50 g/cc, at least about 0.75 g/cc, at least about 1.00 g/cc, at least about 1.25 g/cc, or even at least about 1.50 g/cc. Additionally or alternatively, the density of the product is at least about 25%, preferably at least about 30%, more preferably at least about 40% less than the density of the substrate. Additionally or alternatively, the density of the product, when swelled in water is between about 0.75 and about 1.25 g/cc, such as between about 0.9 and 1.15 g/cc.

Meanwhile, the maximum amount of water-swellable composite coating used will generally be limited by practical considerations in the sense that this amount is desirably not so much that no practical advantage is realized in terms of the increase in buoyancy provided by this coating. That is, as the density of the swellable product, as a function of the coating thickness, will substantially plateau. The coating thickness at which the product density plateaus can be determined by routine experimentation. Thus, the amount, or thickness, of the coating layer will preferably have a thickness which is less than the amount at which the density plateaus.

For example, in embodiments of this invention in which frac sand (density ˜2.65 g/cc) is used as the proppant substrate particle, the amount of water-swellable composite coating used on a dry weight basis will generally be about 0.5 to 40 wt. %, more typically 0.75 to 20 wt. %, 1 to 15 wt. %, about 1.3-12 wt. %, or even 2-10 wt. % based on the weight of the frac sand used. In some embodiments, for example where a greater degree of buoyancy is desired, the amount of water-swellable composite coating used on a dry weight basis will generally be about 3 to 40 wt. %, more typically 3.3 to 20 wt. %, 3.5 to 15 wt. %, about 3.75-10 wt. %, or even 4-8 wt. % based on the weight of the frac sand used. In other embodiments, for example where less buoyancy is desired, the amount of water-swellable composite coating used on a dry weight basis will generally be about 0.5 to 20 wt. %, more typically about 1 to 15 wt. %, about 1.25-10 wt. %, about 1.5-7.5 wt. %, about 1.75-5 wt. % or even about 2-4 wt. % based on the weight of the frac sand used.

When other proppant substrate particles are used, comparable amounts of these hydrogel polymers can be used. For example, if an intermediate density ceramic having a density of about 3.27 g/cc is used, the amount of water-swellable composite coating used on a dry weight basis can be about 1.23 (3.27/2.65) times the above amounts on a dry weight basis if the same relative increase in buoyancy is desired. If a greater amount of buoyancy is desired, more water-swellable composite coating can be used, while if a less amount of buoyancy is desired, less water-swellable composite coating can be used, all of which can be easily determined by routine experimentation.

In this regard, a particular advantage of this invention as compared with our earlier invention in which a gelatinized cationic starch is used as the water-swellable polymer, as described in the above-noted U.S. Ser. No. 62/337,547 (Atty. Docket 17922/05168), is that the amount of water-swellable composite coating that is needed to achieve a given amount of buoyancy in aqueous liquids containing high concentrations of calcium and other cations is considerably less than that required to make the self-suspending proppants of our earlier invention. For example, when comparing the inventive self-suspending proppants with those of our earlier invention on an equivalent basis, i.e., when made with the same sand particle substrate and tested in the same calcium ion-rich aqueous test liquid to achieve essentially the same increase in buoyancy, it takes only about 4 to 5 wt. % of the water-swellable composite coating of this invention as compared with the 7 to 9 wt. % cationic hydrogel polymer of our earlier invention. This can represent a significant savings in material costs.

More importantly, this difference also translates into a substantial savings in production costs, because the total amount of volatiles involved when producing the inventive self-suspending proppants is less than involved when producing our earlier self-suspending proppants. The hydrogel polymers used in this invention and our earlier invention can preferably be supplied in the form of polymer emulsions. To produce product proppants in dry form, the carrier liquids in these emulsions need to be driven off, for example, by evaporation through heating. Because the total amount of hydrogel polymer is less when the inventive proppants are made, the energy costs needed to achieve this evaporation is correspondingly less.

For example, the total volatiles involved in making a self-suspending proppant containing 9.7 wt. % cationic starch in accordance with our earlier invention is about 355.6 lb/ton. In contrast, the total volatiles involved in making a roughly equivalent self-suspending proppant containing 4.0 wt. % of the water-swellable composite coating of this invention is only about 114.5 lb/ton. Thus, the cost of producing this inventive proppant would be considerably less, because less energy is needed to drive off the volatiles involved in its production.

A still further advantage of this invention as it relates to our earlier invention is temperature control during the proppant gelatinization/drying process when a starch is used as one of the hydrogel polymers. When the self-suspending proppants of our earlier invention are made using large amounts of starch, starch gelatinization involved controlled ramping of the temperatures from gelatinization through drying. This controlled temperature ramping is unnecessary when the inventive proppants are made, as it has been found that sufficient starch gelatinization occurs when these proppants are made as described, for example, in commonly assigned U.S. Pat. No. 9,297,244 and U.S. Pat. No. 9,315,721, the disclosures of which are incorporated herein by reference.

The relative amounts of the anionic, cationic and nonionic hydrogel polymers in the water-swellable composite coating of the inventive self-suspending proppant are not critical, and essentially any amounts can be used, provided that this coating comprises at least two of these different types of hydrogel polymers. Typically, the cationic polymer is added to the coating in at least an amount sufficient to bind ions in the fracturing fluid. Typically, the anionic polymer is more effective at swelling than the cationic polymer or nonionic polymer. Accordingly the anionic polymer is added to the coating in an amount sufficient to provide the degree of swelling and buoyancy discussed above. Typically, the nonionic polymer, particularly a starch-based polymer, is less expensive than the anionic polymer and is added to the coating in an amount to reduce the cost of the coating and absorb any ions not bound by the cationic polymer.

When this coating comprises the combination of only two of these hydrogel polymers, such combinations will generally include at least 10 wt. % of each of these hydrogel polymers, more typically at least 20 wt. %, at least 30 wt. % or even at least 40 wt. % of each of these hydrogel polymers. On the other hand, when this coating comprises the combination of all three of these hydrogel polymers, such combinations will generally include at least 1 wt. % of each of these hydrogel polymers, more typically at least 3 wt. %, at least 5 wt. %, at least 10 wt. %, at least 15 wt., at least 20 wt. %, or even at least 30 wt. % of each of these hydrogel polymers. In both cases, it will be understood that these proportions apply whether each type of hydrogel polymer is composed of only a single hydrogel polymer or mixtures of two of more hydrogel polymers of the same type.

Alternatively or additionally, the amount of the anionic polymer, when present, to total polymer will be at least about 3, such as at least about 5 wt %, preferably at least 10 wt %, on a dry weight basis. Preferably, the amount of the anionic polymer to total polymer will be less than about 50 wt %, preferably less than 30 wt %, on a dry weight basis. Alternatively or additionally, the amount of the cationic polymer, when present, to total polymer will be at least about 15 wt %, 25 wt %, 30 wt %, 35% wt %, 40% wt %, 45% wt %, 50% wt %, 55% wt %, 60% wt %, 65% wt %, 70% wt %, 75% wt %, or 80% wt %, each on a dry weight basis. Preferably, the amount of the nonionic polymer, when present, to total polymer will be at least about 15, such as at least about 25 wt %, preferably at least 30 wt %, more preferably at least about 50% on a dry weight basis.

In an embodiment, the coating consists of a covalent crosslinker, anionic polymer, cationic polymer and optional nonionic polymer. In an embodiment, the cationic and anionic polymers are each polyacrylamides present in a ratio of about 4:1 by weight.

In certain embodiments of the invention, as described above, the water-swellable composite coating of the inventive self-suspending proppant will be composed of two coating layers, a first-applied coating layer and a second-applied coating layer, with one of these coating layers comprising an anionic hydrogel polymer and the other of these coating layers comprising a cationic hydrogel polymer, a nonionic hydrogel polymer or the combination of both. Generally, the first-applied coating layer will be formed from the anionic hydrogel polymer, but it is also possible that this first-applied coating layer can be formed from the cationic hydrogel polymer, as well. In both cases, the relative amounts of the first-applied coating layer and the second-applied coating layer can vary widely and essentially any relative amount can be used. Generally, the amounts used will be such that the ratio of the first-applied coating layer to the second-applied coating layer, on a dry weight basis, is 1:6 to 5:1, more typically, 1:4 to 3:1, 1:3 to 2:1, or even 1:2 to 1:1.

### Chemical Modification for Enhancing Coating Adhesion

In order to improve the durability of the water-swellable composite coating of the inventive self-suspending proppant once swollen with its aqueous hydraulic fracturing fluid, one or more of its elements, including all of its elements, can be chemically treated by one or more adhesion-promoting approaches. In this context, the “elements” of the inventive self-suspending proppants will be understood to include its proppant substrate particle and its water-swellable composite coating, as well as each of the individual components and/or ingredients forming this coating.

In accordance with one such approach, one or more of the hydrogel polymers forming this coating can be crosslinked. For this purpose any di- or polyfunctional crosslinking agent having two or more functional groups capable of reacting with the anionic and/or cationic hydrogel polymer can be used. Examples include organic compounds containing and/or capable of generating at least two of the following functional groups: epoxy, carboxy, aldehyde, isocyanate, amide, vinyl, and allyl. In some instances, especially when the anionic hydrogel polymer is being crosslinked, polyfunctional inorganic compounds such as borates, zirconates, silicas and their derivatives can also be used as can guar and its derivatives.

Specific examples of polyfunctional crosslinking agents that can be used in this invention include epichlorohydrin, polycarboxylic acids, carboxylic acid anhydrides such as maleic anhydride, carbodiimide, formaldehyde, glyoxal, glutaraldehyde, various diglycidyl ethers such as polypropylene glycol diglycidyl ether and ethylene glycol diglycidyl ether, other di-or polyfunctional epoxy compounds, phosphorous oxychloride, sodium trimetaphosphate and various di-or polyfunctional isocyanates such as toluene diisocyanate, methylene diphenyl diisocyanate and polymers thereof, 1-ethyl-3-(3-dimethylaminopropyl) carbodiimide, methylene bis acrylamide, naphthalenediisocyanate, xylene-diisocyanate, tetramethylene diisocyanate, hexamethylene diisocyanate, trimethylene diisocyanate, trimethyl hexamethylene diisocyanate, cyclohexyl-1,2-diisocyanate, cyclohexylene-1,4-diisocyanate, and diphenylmethanediisocyanates such as 2,4′-diphenylmethanediisocyanate, 4,4′-diphenylmethanediisocyanate and mixtures thereof.

The amount of such crosslinking agents that can be used can vary widely, and essentially any amount can be used. Generally, however, the amount used will be about 1 to 50 wt. %, more typically about 1 to 40 wt. %, about 3 to 40 wt. %, about 3 to 25 wt. %, about 5 to 40 wt. %, about 5 to 25 wt. %, or even about 5 to 12 wt. %, based on the dry weight of the hydrogel polymer that is being crosslinked.

If a crosslinking agent is used, it can be added to the other ingredients at any time during preparation of the inventive self-suspending proppant. For example, in all embodiments of this invention, it can be added to the proppant substrate particle before it is combined with any other ingredient. Additionally or alternatively, it can be added to each hydrogel polymer before it is combined with the other ingredients forming the inventive self-suspending proppant. Additionally or alternatively, it can also be added to each hydrogel polymer after a coating layer made from that hydrogel polymer is formed, thereby surface crosslinking that coating layer.

For example, the outermost surface of the water-swellable composite coating of the inventive self-suspending proppant can be surface crosslinked by adding the crosslinking agent after all of the hydrogel polymers have been added. Additionally and/or alternatively, a crosslinking agent can be added after some but not all of the hydrogel polymers have been added, thereby producing one or more intermediate coating layers which themselves are surface crosslinked. For example, a crosslinking agent can be added after the addition of the first-applied hydrogel polymer is complete but before the addition of the second-applied hydrogel polymer begins. Additionally and/or alternatively, a crosslinking agent can be added after the addition of the second-applied hydrogel polymer is complete but before the addition of the third-applied hydrogel polymer begins.

When a crosslinking agent is used, a catalyst for the crosslinking agent can also be included, if desired. Examples of suitable catalysts include acids, bases, amines and their derivatives, imidazoles, amides, anhydrides, and the like. These catalysts can be added together with the crosslinking agent or separately. If added separately, they can be added at any time during the preparation of the inventive self-suspending proppant, in the same way as the crosslinking agent, as described above.

Another adhesion-promoting approach that can be used is pretreating the proppant substrate particles with a suitable adhesion promoter. For example, the proppant substrate particles can be pretreated with a silane coupling agent before it is combined with the hydrogel polymer forming the first coating. The chemistry of silane coupling agents is highly developed, and those skilled in the art should have no difficulty in choosing particular silane coupling agents for use in particular embodiments of this invention.

If desired, the silane coupling agent can be a reactive silane coupling agent. As well understood in the art, reactive silane coupling agents contain a functional group capable of reacting with functional groups on the polymers to be coupled. In this invention, therefore, the particular reactive silane coupling agents used desirably contain functional groups capable of reacting with the pendant hydroxyl, hydroxy methyl or other electronegative groups of the hydrogel polymer forming the first coating layer of the inventive proppants. Examples of such reactive silane coupling agents include vinyl silanes such as vinyl trimethoxy silanes, vinyl ethoxy silanes and other vinyl alkoxy silanes in which the alkyl group independently have from 1 to 6 carbon atoms. Other examples include reactive silane coupling agents which are based on one or more of the following reactive groups: epoxy, glycidyl/epoxy, allyl, and alkenyl.

Another type of adhesion promoter that can be used include agents which provide a wetting/binding effect on the bond between the proppant substrate particle and the hydrogel polymer forming the first coating layer. Examples include reactive diluents, wax, water, surfactants, polyols such as glycerol, ethylene glycol and propylene glycol, various tackifiers such as waxes, glues, polyvinyl acetate, ethylene vinyl acetate, ethylene methacrylate, low density polyethylenes, maleic anhydride grafted polyolefins, polyacrylamide and its blends/copolymerized derivatives, and naturally occurring materials such as sugar syrups, gelatin, and the like. Nonionic surfactants, especially ethoxylated nonionic surfactants such as octylphenol ethoxylate, are especially interesting.

Still another type of adhesion promoter that can be used is the crosslinking agents mentioned above. In other words, one way these crosslinking agents can be used is by pretreating the proppant substrate particles with them before these particles are mixed with the hydrogel polymer forming the first coating layer, as described above.

### Drying

In accordance with this invention, the intermediate product produced when the water-swellable composite coating is formed on the proppant substrate particles is dried to produce a mass of free-flowing self-suspending proppants. Drying can be done without application of heat, if desired, such as applying a vacuum. Generally, however, drying can be done by heating the mixture at temperatures as low as 40° C. and high as 300° C., for example. Generally, however, drying will be done at temperatures above the boiling point of water such as, for example, at >100° C. to 300° C., >100° C. to 200° C., 105° C. to 150° C., 110° C. to 140° C. or even 115° C. to 125° C.

Also, in those embodiments in which one or more of the hydrogel polymers used is a starch which is heated for gelatinization in an earlier process step, as described above, drying will generally be done at drying temperatures which are higher than the gelatinization temperature by at least 20° C., more typically at least 30° C., at least 40° C., or even at least 50° C. In addition, in carrying out this drying step, although the mixture being dried can be left physically undisturbed until drying is completed, it is more convenient to subject it to occasional mixing during drying, as this helps keep the individual coated proppant particles from sticking to one another, thereby minimizing particle clumping and agglomeration.

One way that drying can be done is by placing the mixture in a conventional oven maintained at a desired elevated temperature. Under these conditions, drying will generally be completed in about 30 minutes to 24 hours, more typically about 45 minutes to 8 hours or even 1 to 4 hours. Moreover, by occasionally mixing the mass during this drying procedure, for example, once every 10 to 30 minutes or so, clumping and/or agglomeration of the coated proppant will be largely avoided, resulting in a free-flowing mass of proppants being produced.

Another convenient way of drying the mixture in accordance with this invention is by using a fluidized bed dryer in which the mixture is fluidized by an upwardly flowing column of heated air. Fluidization causes individual coated proppant particles to separate from one another, which not only avoids clumping/agglomeration but also promotes rapid drying. Drying times as short as 15 minutes, 10 minutes or even 5 minutes or less are possible when fluidized bed dryers are used.

As a result of the manufacturing procedure described above, a mass of individual, discrete starch-coated self-suspending proppants can be produced. Although some clumping and agglomeration might occur, these clumps and agglomerates can generally be broken up by mild agitation. In addition, even if clumping and agglomeration becomes more serious, application of moderate pressure such as occurs with a mortar and pestle will usually be sufficient to break up any agglomerates that have formed.

Properties

The inventive self-suspending proppant, optionally but preferably, is free-flowing when dry. This means that any clumping or agglomeration that might occur when this proppant is stored for more than a few days can be broken up by moderate agitation. This property is beneficial in connection with storage and shipment of this proppant above ground, before it is combined with its aqueous fracturing fluid.

When deposited in its aqueous fracturing fluid, the inventive self-suspending proppant hydrates to achieve an effective volumetric expansion which makes it more buoyant and hence effectively self-suspending. In addition, it retains a significant portion of this enhanced buoyancy even if it is exposed to hard or salty water. Moreover, in some embodiments, it is also durable in the sense that it retains a substantial degree of its self-suspending character (i.e., its enhanced buoyancy) even after being exposed to substantial shear forces.

This enhanced buoyancy can be quantitatively determined by a Settled Bed Height Analytical Test carried out in the following manner: 35 g of the proppant is mixed with 85 ml of the aqueous liquid (e.g., preferably, water) to be tested in a glass bottle. The bottle is vigorously shaken for 1 minute, after which bottle is left to sit undisturbed for 5 minutes to allow the contents to settle. The height of the bed formed by the hydrated, expanded proppant is then measured using a digital caliper. This bed height is then divided by the height of the bed formed by the uncoated proppant substrate particle. The number obtained indicates the factor (multiple) of the volumetric expansion.

In accordance with this invention, the inventive proppant is desirably designed to exhibit a volumetric expansion, as determined by this Settled Bed Height Analytical test when carried out using simulated test waters having different levels of conductivities and hardness, as described in Table 1, of ≥˜1.3, ≥˜1.5, ≥˜1.75, ≥˜2, ≥˜2.25, ≥˜2.5, ≥˜2.75, ≥˜3, or even ≥˜3.5.

In this regard, it will be appreciated that a volumetric expansion of 2 as determined by this test roughly corresponds to cutting the effective density of the proppant in half For example, if an inventive self-suspending proppant made from conventional frac sand exhibits a volumetric expansion of 2 according to this test, the effective density (i.e., the apparent specific gravity) of this frac sand will have been reduced from about 2.65 g/cc to about 1.4 g/cc. Persons skilled in the art will immediately recognize that this significant decrease in density will have a major positive effect on the buoyancy of the proppant obtained which, in turn, helps proppant transport in hydraulic fracturing applications tremendously, avoiding any significant proppant settlement during this time.

In terms of maximum volumetric expansion, persons skilled in the art will also recognize that there is a practical maximum to the volumetric expansion the inventive proppant can achieve, which will be determined by the particular type and amount of hydrogel-forming polymers used in each application.

Another feature of the inventive proppant is that its water-swellable composite coating rapidly swells when contacted with water. In this context, “rapid swelling” will be understood to mean that at least 80% of the ultimate volume increase that this coating will exhibit is achieved within a reasonable time after these proppants have been mixed with their aqueous fracturing liquids. Generally, this will occur within 8 to 12 minutes of the proppant being combined with its aqueous fracturing liquid, although it can also occur within 30 minutes, within 20 minutes, within 10 minutes, within 7.5 minutes, within 5 minutes, within 2.5 minutes or even within 1 minute of this time.

Still another feature of the inventive proppant is durability or shear stability. In this regard, it will be appreciated that proppants inherently experience significant shear stress when they are used, not only from pumps which charge the fracturing liquids containing these proppants downhole but also from overcoming the inherent resistance to flow encountered downhole due to friction, mechanical obstruction, sudden changes in direction, etc. The water-soluble composite coatings of the inventive self-suspending proppants, although inherently fragile due to their hydrogel nature, nonetheless are durable enough to resist these mechanical stresses and hence remain largely intact (or at least associated with the substrate) until they reach their ultimate use locations downhole.

For the purposes of this invention, coating durability can be measured by a Shear Analytical Test in which the settled bed height of a proppant is determined in the manner described above after a mixture of 100 g of the proppant in 1 liter of water has been subjected to shear mixing at a shear rate of about 511 s⁻¹ for a suitable period of time, for example 5 or 10 minutes. The inventive self-suspending proppant desirably exhibits a volumetric expansion, as determined by the above Settled Bed Height Test, of at least about 1.3, more desirably about at least about 1.5, at least about 1.6, at least about 1.75, at least about 2, at least about 2.25, at least about 2.5, at least about 2.75, at least about 3, or even at least about 3.5 after being subjected to the above shearing regimen for 5 minutes using ordinary tap water as the test liquid. Inventive self-suspending proppants which exhibit volumetric expansions of at least about 1.3, at least about 1.5, at least about 1.75, at least about 2, at least about 2.25, at least about 2.5, at least about 2.75 or even at least about 3 after having been subjected to the above shearing regimen for 10 minutes using simulated test waters having different levels of conductivities and hardness, as described in Table 1, are especially interesting.

In addition to the above Shear Analytical Test, another means for assessing coating durability is a Viscosity Measurement Test in which the viscosity of the supernatant liquid that is produced by the above Shear Analytical Test is measured after the proppant has had a chance to settle. If the durability of a particular proppant is insufficient, an excessive amount of its water-swellable composite coating will come off and remain dissolved or dispersed in the supernatant liquid. The extent to which the viscosity of this liquid increases as a result of this dissolved or dispersed coating is a measure of the durability of the water-swellable composite coating. A viscosity of about 20 cPs or more indicates a low coating durability. Desirably, the viscosity of the supernatant liquid will be about 10 cPs or less, more desirably about 5 cPs or less.

### Working Examples

In order to more thoroughly describe this invention, the following working examples are provided.

### Materials

20/40 mesh frac sand
bPEI (Aldrich, St. Louis, Mo.)
FLOPAM EM533: high molecular weight, medium charge anionic polyacrylamide inverse emulsion in petroleum distillate (SNF—Riceboro, Ga.))
EM230: high molecular weight, non-ionic polyacrylamide inverse emulsion in petroleum distillate (SNF—Riceboro, Ga.)
EM235: high molecular weight, very low charge anionic polyacrylamide inverse emulsion in petroleum distillate (SNF—Riceboro, Ga.)
EM430: high molecular weight, low charge anionic polyacrylamide inverse emulsion in petroleum distillate (SNF—Riceboro, Ga.)
EMR2545: very high molecular weight, medium charge cationic polyacrylamide inverse emulsion in petroleum distillate (SNF—Riceboro Ga.)
EM1540 CT: high molecular weight, low charge cationic polyacrylamide inverse emulsion in petroleum distillate (SNF—Riceboro, Ga.)
FB608: very high molecular weight, very high charge cationic polyacrylamide inverse emulsion in petroleum distillate (SNF—Riceboro, Ga.)
FB 808: very high molecular weight, very high charge cationic polyacrylamide inverse emulsion in petroleum distillate (SNF—Riceboro, Ga.)
Glycerol (US Glycerin, Kalamazoo, Mich.)
ethylene glycol
polymeric methylenediphenyldiisocyanate
Bis(3-dimethylaminopropyl)-n,n-dimethylpropanediamine (PolyCat 9: Air Products, Allentown, Pa.)
Potassium Chloride (The Home Depot, Atlanta, Ga.)
Calcium Chloride (Amazon-Home Brew Ohio, Sandusky, Ohio)
Calcium Chloride Dihydrate (Aldrich, St. Louis, Mo.)
Sodium Chloride (The Home Depot, Atlanta, Ga.)
Anhydrous sodium sulfate (Aldrich, St. Louis, Mo.)
magnesium chloride hexahydrate (Aldrich, St. Louis, Mo.)
Charge Master L340 Starch (Grain Processing Corporation, Muscatine, Iowa)

TABLE 1
SNF Polymer Emulsion Information

| Polymer Emulsion | Charge | Molecular Weight | Structure* |
|---|---|---|---|
| EM533 | Medium Anionic | High | |
| EM230 | Non-ionic | High | |
| EM235 | Very low Anionic | High | |
| EM430 | Low Anionic | High | |
| EMR2545 | Medium Cationic | Very High | Structured |
| EM1540 CT | Low cationic | High | Linear |
| FB 608 | Very High Cationic | Very High | Structured |
| FB 808 | Very High Cationic | Very High | Structured |

*Where applicable

As used herein, the terms very high and high molecular weight and very high, high, medium, low and very low anionic or cationic charge have those meanings attributed to the polymers in the art, such as the polymers commercially available as of the filing date of this application by SNF Floerger, http://snfus/wp-content/uploads/2014/07/SNF-Industrial-Product-Selection-Guide-4-15-14.pdf. For example, FB608 has a cationic charge of about 60 mole %. FB808 has a cationic charge of about 80 mole %. Therefore, a very high cationic charge is meant to include polymers having a charge of at least about 60 mole %. A high cationic charge is meant to include polymers having a charge of between about 40 and 60 mole %. A medium cationic charge is meant to include polymers having a charge of between about 20 and 40 mole %. A low cationic charge is meant to include polymers having a charge of between about 0.75 and 20 mole %. A high anionic charge is meant to include polymers having a charge of at least about 60 mole %. A medium anionic charge is meant to include polymers having a charge of between about 20 and 60 mole %. A low anionic charge is meant to include polymers having a charge of between about 3 and 20 mole %.

### Example 1: Two-Component Approach Vs. One-Component Approach

90 g of 20/40 mesh sand was added to a FlackTek cup, along with 0.09 g of a pre-coat containing 5 wt % ethylene glycol and 95 wt % water. The pre-coated sand was mixed at 850 RPM for 15 seconds. Separately, a coating composition was made up containing 10 wt % glycerol and 90 wt % of a commercially-available cationic polyacrylamide inverse emulsion (FB608) containing approximately equal amounts of a high molecular weight hydrogel-forming cationic polyacrylamide copolymer, water and a hydrocarbon carrier liquid. The weight ratio of hydrogel-forming polymer to glycerol in this coating composition was about 3:1. 11.34 g of the aforementioned cationic polyacrylamide inverse emulsion with 1.26 g glycerol was added to the 20/40 mesh sand and mixed at 1500 RPM for 30 seconds. 2.5 g of a commercially-available liquid pMDI (polymeric methylenediphenyldiisocyanate) covalent crosslinking agent was subsequently added and then mixed in the same mixer at 850 RPM for 30 seconds. 1 g of a commercially available pMDI catalyst, known as PolyCat 9, was added in and mixed the same way. The coated proppants produced were oven dried for 30 minutes at 90° C. The sample was removed from the oven after 15 minutes and was broken up by hand to allow for improved drying. The sample was then sieved through an 18-mesh screen.

Another sample was prepared in the same way, except that an anionic polyacrylamide emulsion (EM 533) was used instead of a cationic one. This sample, along with the one including the cationic emulsion, represent a single-component approach.

The last sample was prepared in the same way, except that both anionic and cationic polymers (EM533 and FB608) were added sequentially. 3.63 g of cationic polyacrylamide emulsion with 0.4 g glycerol was added, mixed on 850 RPM for 15 seconds, followed by 0.91 g of anionic polyacrylamide emulsion with 0.1 g glycerol and then an additional 15 seconds of mixing. Other chemicals were added as described, and it was dried in the same manner.

Sand samples prepared were assessed for performance in a settled bed height test. Settling heights were obtained by adding (3 ppg) 54 g of the coated sand sample to 150 mL of water in a small jar. Water that had 6,400 ppm of hardness and 29,000 ppm of potassium chloride dissolved solids was used to prepare a hard water replica for the purposes of these Examples. The hard water replica recipe is shown in Table 2. The jar was inverted and gently shaken a few times, and it was left to settle for five minutes. The height of the sand layer after 5 minutes was measured with calipers and compared against the height of the same amount of bare sand.

TABLE 2
Hard Water Recipe #1 (6.4k hardness, 29.6k ppm TDS)

| Salt | Concentration (g/L) |
|---|---|
| Potassium Chloride | 22.5 |
| Calcium Chloride | 7.1 |

There was 178% swelling in the sample with cationic polyacrylamide only, 96% swelling in the sample with anionic only, and the sample with the two-polymer approach had similar swelling to the anionic sample with less than half the amount of polymer. This example shows that the multi-component approach containing an anionic and cationic polymer leads to a higher settled bed height per amount of polymer added than just using a single component. In addition, the clarity of the supernatant for the two-component sample is much improved over both the cationic-only or anionic-only samples.

### Example 2: Order/Method of Addition

1000 g of 20/40 mesh sand was added to a Kitchen Aid mixer, along with 1 g of a pre-coat formulation containing 5 wt % ethylene glycol and 95 wt % water. The pre-coated sand was stirred at the lowest speed of the mixer for one minute. Separately, a coating composition was made up containing 10 wt % glycerol and 90 wt % of a commercially-available cationic polyacrylamide inverse emulsion (FB608) containing approximately equal amounts of a high molecular weight hydrogel-forming cationic polyacrylamide copolymer, water and a hydrocarbon carrier liquid. The weight ratio of hydrogel forming polymer to glycerol in this coating composition was about 3:1. 48.39 g of the aforementioned cationic polyacrylamide inverse emulsion with 5.37 g glycerol was added to the 20/40 mesh sand. 12 g of a high molecular weight hydrogel-forming anionic polyacrylamide (EM533) inverse emulsion with 1.33 g glycerol was also added to the 20/40 mesh sand at the same time, and the mixture was then stirred at the lowest speed of the mixer for 3.5 minutes. The ratio of cationic to anionic polyacrylamide was 4:1. 2.5 g of a commercially-available liquid pMDI (polymeric methylenediphenyldiisocyanate) covalent crosslinking agent was subsequently added. This was mixed in the same mixer on the lowest setting for two minutes. 1 g of a commercially available pMDI catalyst, known as PolyCat 9, was added in and mixed the same way for 1.5 minutes. The coated proppants produced thereby were split into two groups. One group was dried in an oven for 30 minutes at 90° C., and the other group was dried in a fluidized bed dryer for 7 minutes at 90° C. on a speed setting of 42 rpm. The sample in the oven was taken out after 15 minutes and was broken up by hand to allow for improved drying. Both samples were sieved through an 18-mesh screen.

Three more samples were prepared in the same way, except the cationic and anionic polyacrylamide (FB608 and EM533) were added in different manners. For one sample, the cationic polymer with glycerol was added first, mixed in the manner described, and then the anionic with glycerol was added and mixed as described. For the other sample, the anionic polymer with glycerol was added first, mixed in the manner described, and then the cationic with glycerol was added and mixed as described. For the last sample, the anionic and cationic polymer emulsions with glycerol were pre-mixed in the same 4:1 ratio and then added in one step to the sand.

Sand samples prepared as described above were assessed for performance in a settled bed height test. Settling heights were obtained by adding 35 g of the coated sand sample to 84 mL of water in a small jar. Two different types of water were used as suspending fluid for these tests: Hard Water Recipe #2 and Hard Water Recipe #3. These water recipes are shown in Tables 3 and 4.

Using these recipes to produce the suspending fluid for settled bed height testing, the following experiments were performed. First, the height of 35 g of coated sand is measured in the graduated cylinder. The 35 g of coated sand is then added to 84 mL of water in the small jar. The jar was vigorously shaken for one minute, left to settle for five minutes, and then inverted one more time and poured into a 100 mL graduated cylinder. After five minutes of settling in the graduated cylinder, the height of the sand layer was measured. Settled bed heights from these tests are reported in Table 5.

TABLE 3
Hard Water Recipe #2 (6.4k hardness, 29.6k ppm TDS)

| Salt | Concentration (g/L) |
|---|---|
| Sodium Chloride | 24 |
| Calcium Chloride Dihydrate | 1.5 |
| Anhydrous sodium sulfate | 4.0 |
| Magnesium Chloride hexahydrate | 10.8 |
| Potassium Chloride | 0.7 |

TABLE 4
Hard Water Recipe #3 (40k hardness, 350k ppm TDS)

| Salt | Concentration (g/L) |
|---|---|
| Sodium Chloride | 138.9 |
| Calcium Chloride Dihydrate | 9.6 |
| Anhydrous sodium sulfate | 4.0 |
| Magnesium Chloride | 67.7 |
| hexahydrate | |
| Potassium Chloride | 80.0 |

TABLE 5
Settled Bed Heights

| | | Hard Water Recipe #2 | | | Hard Water Recipe #3 | | |
|---|---|---|---|---|---|---|---|
| | | Dry Coated | Settled Bed | Swelling | Dry Coated | Settled Bed | Swelling |
| | | Proppant | Height | Percentage | Proppant | Height | Percentage |
| | | (mm) | (mm) | (%) | (mm) | (mm) | (%) |
| Simultaneous | Fluidized | 22 | 42 | 91 | | | 50* |
| Addition | Bed | | | | | | |
| | Oven* | N/A | N/A | N/A | N/A | N/A | 40* |
| Anionic | Fluidized | N/A | N/A | N/A | N/A | N/A | 90* |
| Before | Bed* | | | | | | |
| Cationic | Oven* | N/A | N/A | N/A | N/A | N/A | 40-50* |
| Cationic | Fluidized | 23 | 39 | 70 | 23 | 41 | 78 |
| Before | Bed | | | | | | |
| Anionic | | | | | | | |
| Premixed | Fluidized | 22 | 54.5 | 148 | 22 | 46 | 109 |
| | Bed | | | | | | |

*Indicates measurement by visually estimating the swelling percentage.

This is a process that does not involve emptying contents into a graduated cylinder. Instead, bed height is estimated from the height in the jar after 1 minute of shaking and 5 minutes of settling.

As additional findings, we observed visually that oven drying produced product that was more prone to caking and had less flowability. Fluidized bed drying produced higher settled bed heights. These experiments showed that a premixed version of cationic and anionic polyacrylamide emulsion delivered the highest settled bed heights.

### Example 3: Differing Ratios

Samples were created in the same manner and with the same materials as discussed in Example 1. This time, the polymer emulsion addition contained both the anionic and cationic polymers (EM533 and FB608), but the cationic emulsion was added first, mixed in the FlackTek mixer, and then the anionic emulsion was added in, mixed in the mixer. Following this, the other chemicals were added and drying procedures were performed as described in Example 1. Four different samples were created in this manner, with varying ratios of cationic to anionic polymer emulsion but with the same total amount of emulsion added; also, two other samples were created as controls, with one having only the cationic emulsion and the other having only the anionic emulsion. Settled bed heights were measured in the same manner as described in Example 1, and they were remeasured two days after shaking. Table 6 shows the makeup of each sample and the settled bed height results, using Hard Water Recipe #1 that was described in Table 2 of Example 1.

TABLE 6
Settled Bed Heights for Varying Ratios of Cationic to Anionic Polymer Emulsions

| | | | | Settled Bed | Settled Bed |
|---|---|---|---|---|---|
| | | | | Height After Two | Height Change |
| % Cationic/ | Dry Bare Sand | Settled Bed | Swelling | Days of Settling | After Two Days |
| % Anionic | Height (mm) | Height (mm) | Percentage (%) | (mm) | (mm) |
| 60/40 | 11.5 | 24.02 | 109 | 18.54 | 5.48 |
| 70/30 | | 20.28 | 76 | 18.88 | 1.40 |
| 80/20 | | 22.56 | 96 | 18.72 | 3.84 |
| 90/10 | | 21.16 | 84 | 19.47 | 1.69 |
| 100/0 | | 22.26 | 94 | 18.91 | 3.35 |
| 0/100 | | 17.88 | 55 | — | — |

The sample with 100% cationic emulsion had the most turbid water, consistent with the polymer coating shedding from the sand. This finding suggests that, although swelling is similar, the multi-component approach performs without as much polymer shedding. The anionic polymer alone does not perform as well in several regards.

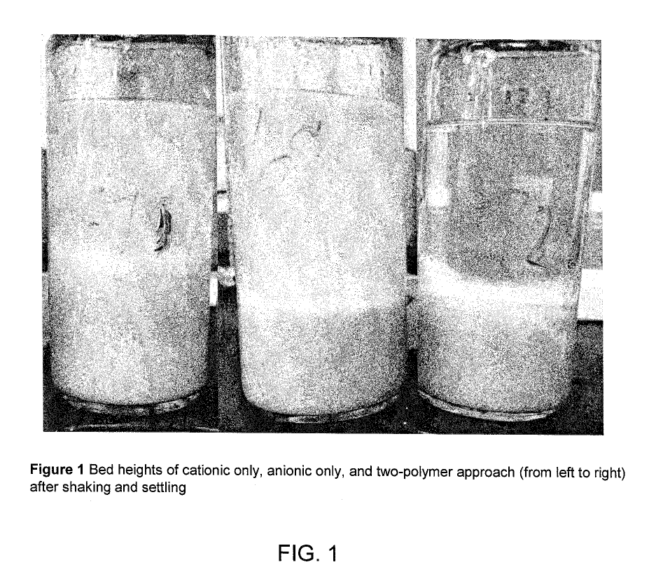

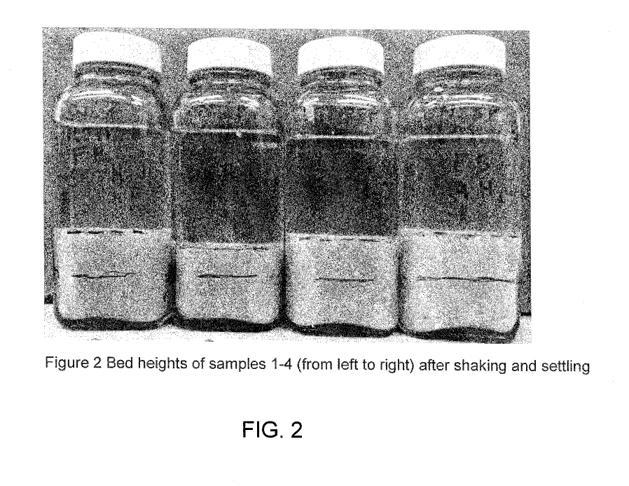

In a second test, more ratios of cationic to anionic polymer emulsions were tested, using the KitchenAid process and settled bed height testing process outlined in Example 2, and using the hard water recipes from Example 2. Results showed that the 80/20 ratio with premixed polymer produced superior results to other ratios with cationic and anionic emulsions added sequentially. Tables 7 and 8 and FIG. 2 illustrate these results. Because Samples 1 and 4 produced the best qualitative results (as shown in FIG. 1), these were emptied into graduated cylinders for additional measurement.

TABLE 7
Settled Bed Heights for Varying Ratios of
Cationic to Anionic Polymer Emulsions in Hard Water Recipe #1
(using the KitchenAid process from Example 2)

| | | Dry Coated | Settled | |
|---|---|---|---|---|
| | | Proppant | Bed | Swelling |
| | | Height | Height | Percentage |
| Sample | % Cationic/% Anionic | (mm) | (mm) | (%) |
| 1 | 80/20 premixed | 22 | 54.5 | 148 |
| 2 | 50/50 sequential addition* | N/A | N/A | 60* |
| 3 | 70/30 sequential addition* | N/A | N/A | 90* |
| 4 | 92.5/7.5 sequential addition | 24 | 70 | 192 |

*Indicates measurement by visually estimating the swelling percentage.

This is a process that does not involve emptying contents into a graduated cylinder. Instead, bed height is estimated from the height in the jar after 1 minute of shaking and 5 minutes of settling.

The bed height of sample 4 decreased to 64 mL after ten minutes and to 62 after 15 minutes, whereas the bed height of sample 1 stayed more constant over a 15-minute timeframe.

TABLE 8
Settled Bed Heights for Varying Ratios of Cationic to Anionic Polymer
Emulsions in Hard Water Recipe #3 with Alternative Process

| | | Dry Coated | | |
|---|---|---|---|---|
| | | Proppant | | Swelling |
| | | Height | Settled Bed | Percentage |
| Sample | % Cationic/% Anionic | (mm) | Height (mm) | (%) |
| 1 | 80/20 premixed | 22 | 46 | 109 |
| 4 | 92.5/7.5 sequential | 24 | 44 | 83 |
| | addition | | | |

### Example 4: Different Polymers—bPEI

Samples were created in the same manner and with the same materials as described in Example 1. This time, the polymer emulsion addition contained either an anionic or cationic polymer (outlined in Table 9) and a commercially available low molecular weight branched polyethyleneimine (bPEI) (from Sigma Aldrich, with a weight average molecular weight of 2000, provided as a 50% solution in water). This bPEI was added first mixed in the FlackTek mixer for 15 seconds at 850 RPM, and then the emulsion was added in, mixed for 15 seconds at 850 RPM, and the other chemicals were added as described previously, and drying was done for 15 minutes at 90° C.

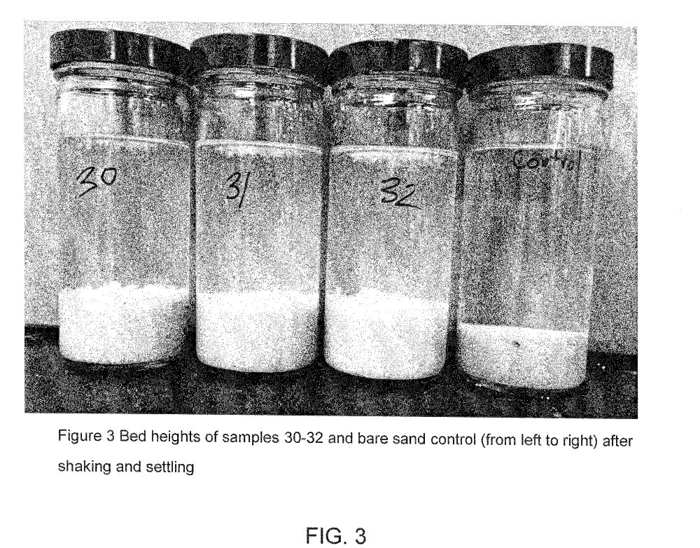

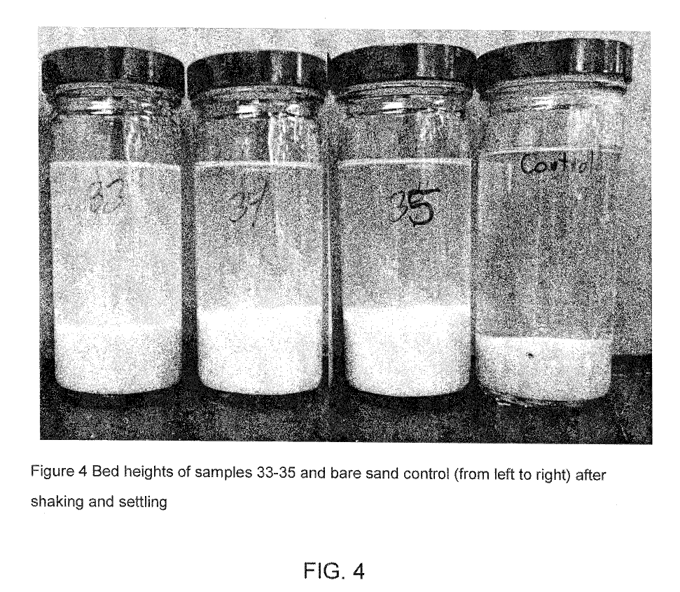

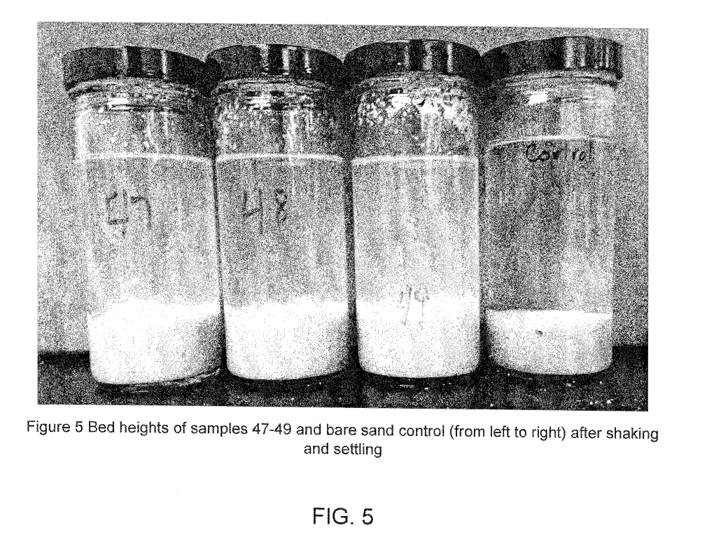

Varying amount of bPEI were added. Settled bed heights were obtained as described in Example 1, using Hard Water Recipe #1. Table 9 shows the makeup of each sample and its swelling percentage. Certain of these samples are illustrated in FIG. 3-5.

TABLE 9
Sample Makeup and Settled Bed Heights
for Multi-Component Testing with bPEI

| | bPEI | | | Polymer | |
|---|---|---|---|---|---|
| | Amount | | Polymer | Amount | Swelling |
| Sample | (g) | bPEI Addition | Layer | (g) | Percentage (%) |
| 30 | 0.9 | Before | EM1540 | 2.52 | 50 |
| 31 | | Polymer | EM235 | | 59 |
| 32 | | Layer | EM230 | | 59 |
| 33 | 1.8 | | EM1540 | | 56 |
| 34 | | | EM235 | | — |
| 35 | | | EM230 | | 61 |
| 47 | 0.685 | Premixed into | EM1540 | 1.835 | 47 |
| 48 | | Polymer | EM235 | | 41 |
| 49 | | | EM230 | | 53 |

We observed that the multi-component system swelled somewhat in hard water, but it did not appear to offer much improvement in settled bed height as compared to that of a single polymer emulsion alone. The addition of bPEI did not appear to influence swelling significantly. Turbidity in some of the samples suggested that there was polymer shedding to various extents.

### Example 5: Different Polymers—Starches

Samples were created in the same manner and with the same materials as discussed in Example 1. This time, the polymer emulsion addition contained either an anionic or cationic polymer (outlined in Table 10) and a commercially available, pregelatinized cationic starch. As before, the previously discussed ethylene glycol and water mixture was added first to 90 g of sand, mixed as described in Example 1, and then the starch was added. The starch used was Charge Master L430. The starch was then added to the sand mixed in the FlackTek mixer for 15 seconds at 850 RPM, and dried for 20 minutes at 90° C. Then the test emulsion was added in, mixed for 15 seconds at 850 RPM; other chemicals were added as described in Example 1, and drying was done for 20 minutes at 90° C.

Varying amounts of the pregelatinized cationic starch were added. Settled bed heights were measured in the same manner, using the hard water recipe described in Example 1. Table 10 shows the makeup of each sample and its swelling percentage.

TABLE 10
Sample Makeup and Settled Bed Heights
for Multi-Component Testing with Starch

| | Starch | | | Polymer | |
|---|---|---|---|---|---|
| | Amount | Starch | Polymer | Amount | Swelling |
| Sample | (g) | Addition | Layer | (g) | Percentage (%) |
| 14 | 1.35 | Before | EM533 | 3.00 | 26 |
| 15 | | Polymer | EM1540 | | 59 |
| 16 | | Layer | EMR 2545 | | 50 |
| 17 | | | EM235 | | 47 |
| 18 | | | EM230 | | 50 |
| 19 | | | EM430 | | 41 |
| 20 | 2.70 | | EM 533 | 2.52 | 44 |
| 21 | | | EM1540 | | 53 |
| 22 | | | EM1540 | | 41 |
| 23 | | | EMR2545 | | 53 |
| 24 | | | EM235 | | 44 |
| 25 | | | EM230 | | 59 |
| 26 | | | EM430 | | 47 |
| 27 | | | EM533 | | 38 |

We observed that the multi-component system swelled somewhat in hard water, but it did not appear to offer much improvement in settled bed height as compared to that of a polymer emulsion alone. The amount of starch added did not appear to make a large difference in the resulting swelling. The samples containing emulsions with anionic charges, such as samples containing EM533, EM235, and EM430 generally had lower amounts of swelling. We also observed that the all proppant samples containing starch were very sticky, and large clumps formed.

### Example 6: Removing Glycerol

Glycerol was removed for this set of tests in order to address concerns about humidity tolerance and sample clumping.

Samples were created in the KitchenAid mixer in the same manner and with the same materials as discussed in Example 2 (and oven dried only). This time, the polymer emulsions tested were FB608, FB808, and EM533, and they were added to the sand without glycerol, but all with other chemical amounts were the same, using a 4:1 cationic to anionic emulsion ratio. Both glycerol-free samples were created with the cationic and anionic emulsions premixed. Table 11 shows the settled bed height results. Settled bed height was tested by using the hard water recipe from Example 1 and the test method described in Example 2, except the contents of the jar were poured into the graduated cylinder immediately after shaking and then left to settle in the graduated cylinder for five minutes. Once glycerol was removed and testing was run, a larger difference in premixing vs sequential addition and in varying ratios was seen as well.

TABLE 11
Settled Bed Heights for Multi-Component Testing without Glycerol

| | Dry | | |
|---|---|---|---|
| | Proppant | | Swelling |
| | Bed | Settled Bed | Percentage |
| Sample | Height (mm) | Height (mm) | (%) |
| With Glycerol (with FB608) | 27.0 | 42.0 | 55.6 |
| Without Glycerol (with FB 608) | 25.5 | 45.0 | 76.5 |
| Without Glycerol (with FB 808) | 26 | 49 | 88.5 |

The same amount of total polymer emulsion was used with a 70/30 ratio of cationic to anionic emulsion (they were again premixed) but with varying amounts of glycerol. Results are shown in Table 12.

TABLE 12
Settled Bed Heights for Multi-Component Testing
with Varying Amounts of Glycerol

| | | | Swelling |
|---|---|---|---|
| | Dry Proppant Bed | Settled Bed | Percentage |
| Sample | Height (mm) | Height (mm) | (%) |
| 0% Glycerol (with FB808) | 26.0 | 47.0 | 80.8 |
| 3% Glycerol (with FB608) | 26.0 | 47.0 | 80.8 |
| 5% Glycerol (with FB608) | 26.5 | 44.5 | 67.9 |

Less or a lack of glycerol showed a significant improvement in swelling. The FB808 showed improved results over the FB608 that was used in Examples 1-3. The FB608 and FB808 cationic polyacrylamide emulsions have similar properties. The largest difference is that FB808 has a higher viscosity than FB608. Further testing was completed to show that, without glycerol, premixing emulsions and an 80/20 cationic to anionic emulsion ratio resulted in higher amounts of swelling (Tables 13 and 14).

TABLE 13
Settled Bed Heights for Multi-Component Testing without Glycerol
(with EM533 and FB 608 in KitchenAid)

| | Dry | | |
|---|---|---|---|
| | Proppant | | Swelling |
| | Bed | Settled Bed | Percentage |
| Sample | Height (mm) | Height (mm) | (%) |
| 80/20 Ratio with Premixed | 25.5 | 45.0 | 76.5 |
| Emulsion | | | |
| 80/20 Ratio with cationic added, | 26.5 | 42.5 | 60.4 |
| mixed, and then anionic added | | | |

TABLE 14
Settled Bed Heights for Multi-Component Testing without Glycerol
(with EM533 and FB 808 in FlackTek)

| | Dry Proppant | | Swelling |
|---|---|---|---|
| | Bed | Settled Bed | Percentage |
| Sample | Height (mm) | Height (mm) | (%) |
| 80/20 Ratio with Premixed | 26.0 | 49.0 | 88.5 |
| Emulsion | | | |
| 70/30 Ratio with Premixed | 26.0 | 47.0 | 80.8 |
| Emulsion | | | |

### Example 7

In these examples, self-suspending proppants made in accordance with this invention were tested for their ability to swell when exposed to different simulated test waters. Test waters (TW) 4, 5, 6 and 7 were formulated with varying amounts of CaCl, MgCl, NaCl and KCl to mimic the different types of aqueous liquid generally found in hydraulic fracturing. Test water 1 was formulated to simulate sea water. The properties of these test waters are set forth in the following Table 15:

TABLE 15
Properties of Test Waters (TW)

| | Properties of Each Test Water | | | | |
|---|---|---|---|---|---|
| | Fresh | | | | |
| Property | Water | TW 4 | TW 5 | TW 6 | TW 7 |
| pH | 6.5 | 5.8 | 5.7 | 5.8 | 6.2 |
| Conductivity, | 295 | 19,200 | 115,200 | 242,000 | 501,000 |
| μS | | | | | |
| Hardness, ppm | 120 | 6,400 | 6,400 | 6,400 | 40,000 |
| TDS*, ppm | <1,000 | 29,600 | 69,500 | 136,00 | 350,000 |

*Total Dissolved Solids

### Example 8-Anionic PAM/Cationic Starch Hybrid

1000 g of sand was added to the mixing bowl of a commercial Kitchen Aid mixer. 1 g of a 5% PEG-DGE (polyethylene glycol diglycidyl ether) solution in ethylene glycol:water (5:95) was then added, and the mixture obtained was mixed for an additional 1 minute at speed setting 2 of the machine (about 70 rpm).

25.2 g of a commercially available anionic polyacrylamide inverse emulsion containing approximately one third by weight organic solvent, one third water and one third of an anionic polyacrylamide polymer made by copolymerizing acrylamide and acrylic acid was used to form the first coating of the self-suspending proppants of this example. This was done by thoroughly mixing this anionic polyacrylamide inverse emulsion with 2.8 of glycerol and then adding the mixture so formed to the treated sand in the mixing bowl, with further mixing for 3.5 minutes at a speed setting of 2.

30 g of a 40% aqueous dispersion of a commercially available cationic starch was then used to form the second hydrogel polymer coating of the self-suspending proppants of this example. This was done by adding this starch dispersion to the contents of the mixing bowl, followed by adding 6.4 g of PPGDGE (polypropylene glycol diglycidyl ether) as a crosslinking agent for the starch and 16 g of SM NaOH as a catalyst for the PPGDGE, with continued mixing for an additional 5 minutes at speed setting 3 of the machine. The mixture so obtained was then transferred to a fluidized bed dryer and dried for not more than 5 minutes at 90° C. at 38 rpm.

A number of different runs were made including a control run in which no cationic starch was used. In some cases the partially dried mixture obtained above was transferred back to the Kitchen Aid mixing bowl and further mixed with 2.5 g of a p-MDI covalent crosslinking agent for 2 minutes at speed 2, followed by 2 g of 20% aqueous solution of a tertiary amine catalyst for the p-MDI and mixed for 1.5 minutes at speed 2. In all cases the mixture was transferred into an aluminum foil tray and further dried for 30 minutes at 90° C. in a convection oven to obtain a free flowing coated proppant. Several coatings were made using varying amounts of anionic polyacrylamide emulsion and cationic starch dispersion, keeping all other ingredients the same.

Proppants obtained were then tested using the Settled Bed Height analytical test described above to determine their ability to swell when contacted with the test waters described in Table 15.

The composition of each proppant tested and the results obtained are shown in the following Table 16:

| | Proppant Composition, wt % (dry), based on weight of sand substrate | | | | | |
|---|---|---|---|---|---|---|
| | Control | Run 1 | Run 2 | Run 3 | Run 4 | Run 5 |
| Anionic Polyacrylamide | 0.91 | 0.91 | 0.45 | 1.19 | 1.44 | 1.44 |
| Cationic starch | 0 | 1.20 | 2.00 | 1.60 | 1.32 | 1.32 |
| Total hydrogel | 0.91 | 2.11 | 2.45 | 2.79 | 2.76 | 2.76 |
| PPGDGE | 0 | 0.68 | 0.68 | 0.68 | 0.68 | 0.68 |
| NaOH | 0 | 0.32 | 0.32 | 0.32 | 0.32 | 0.32 |
| pMDI | 0.25 | 0.25 | 0.25 | 0.25 | 0 | 0.25 |
| catalyst | 0.04 | 0.04 | 0.04 | 0.04 | 0 | 0.04 |

Performance Testing--Swelling %

| | | | | | | |
|---|---|---|---|---|---|---|
| Fresh water | 400 | 400 | 400 | 400 | 400 | 400 |
| TW 4 | 10 | 90 | 70-80 | 110-120 | 100 | 100 |
| TW 5 | 10 | 90 | 70-80 | 110-120 | 100 | 100 |
| TW 6 | 10 | 90 | 70-80 | 110-120 | 100 | 100 |
| TW 7 | 10 | 90 | 70-80 | 110-120 | 100 | 100 |

As can be seen from Table 16, the proppants exhibited substantial swelling when exposed to fresh water. However the control proppant, which was made with no cationic starch, exhibited very little swelling when exposed to all four different test waters. On the other hand, the inventive proppants exhibited substantial swelling in different test waters, even though they were made with comparatively little amounts of hydrogel polymer in total.

### Example 9 Cationic PAM/Anionic Starch Hybrid

Example 8 was repeated except that a commercially available cationic polyacrylamide inverse emulsion containing approximately one third polymer, one third organic solvent and one third water was used to form the first coating on the sand substrate particles, while a 40% aqueous dispersion of a commercially available anionic starch was used to form the second hydrogel polymer coating.

The composition of proppants were tested and the results obtained are shown in the following Table 17:

| | Proppant Composition, wt % (dry), | | | | |
|---|---|---|---|---|---|
| | based on weight of sand substrate | | | | |
| | Run 1 | Run 2 | Run 3 | Run 4 | Run 5 |
| Cationic | 0.63 | 0.31 | 0.83 | 1.00 | 1.00 |
| Polyacrylamide | | | | | |
| Anionic starch | 1.20 | 2.00 | 1.60 | 1.32 | 1.32 |
| Total hydrogel | 1.83 | 2.31 | 2.43 | 2.32 | 2.32 |
| PPGDGE | 0.68 | 0.68 | 0.68 | 0.68 | 0.68 |
| NaOH | 0.32 | 0.32 | 0.32 | 0.32 | 0.32 |
| pMDI | 0.25 | 0.25 | 0.25 | 0.25 | 0 |
| catalyst | 0.04 | 0.04 | 0.04 | 0.04 | 0 |

Performance Testing--Swelling %

| | | | | | |
|---|---|---|---|---|---|
| TW 4 | 60 | 70-80 | 80 | 90 | 90 |
| TW 5 | 60 | 70-80 | 80 | 90 | 90 |
| TW 6 | 60 | 70-80 | 80 | 90 | 90 |
| TW 7 | 60 | 70-80 | 80 | 90 | 90 |

As can be seen from Table 17, the inventive proppants exhibited substantial swelling in these different test waters, even though they were also made with comparatively little amounts of hydrogel polymer intotal.

### Example 10 Anionic PAM/Cationic PAM Hybrid

Examples 8 and 9 were repeated, except that the first hydrogel polymer coating was formed from a commercially available anionic polyacrylamide inverse emulsion while the second hydrogel polymer coating was formed from a commercially available cationic polyacrylamide inverse emulsion. Two different commercially available anionic polyacrylamide inverse emulsions were used for this purpose, both of which were formulated from polyacrylamide polymers made by copolymerizing acrylamide with acrylic acid or an acrylic acid salt. Similarly, two different commercially available cationic polyacrylamide emulsions were used for this purpose.

The composition of the proppants were tested and the results obtained are shown in the following Table 18:

| | Proppant Composition, wt % (dry), | | | | |
|---|---|---|---|---|---|
| | based on weight of sand substrate | | | | |
| | Run 1 | Run 2 | Run 3 | Run 4 | Run 5 |
| 1st Cationic | 0 | 0 | 0.72 | 1.08 | 1.08 |
| Polyacrylamide | | | | | |
| 2nd Cationic | 0.99 | 0.99 | 0 | 0 | 0 |
| Polyacrylamide | | | | | |
| 1st Anionic | 0 | 0 | 0 | 0 | 0.83 |
| Polyacrylamide | | | | | |
| 2nd Anionic | 0.99 | 0.66 | 0.50 | 0.50 | 0 |
| Polyacrylamide | | | | | |
| Total hydrogel | 1.98 | 1.65 | 1.22 | 1.58 | 1.91 |
| pMDI | 0.25 | 0.25 | 0.25 | 0.25 | 0.25 |
| Catalyst | 0.4 | 0.4 | 0.4 | 0.4 | 0.4 |

Performance Testing--Swelling %

| | | | | | |
|---|---|---|---|---|---|
| TW 4 | 80 | 40 | 30 | 40 | 70 |
| TW 5 | 80 | 40 | 30 | 40 | 70 |
| TW 6 | 80 | 40 | 30 | 40 | 70 |
| TW 7 | 80 | 40 | 30 | 40 | 70 |

As can be seen from Table 18, all five of the inventive proppants exhibited at least some significant degree of swelling in these different test waters, even though they were made with very small amounts of hydrogel polymer in total.

### Example 11 Hydrolyzed Anionic PAM/Cationic PAM Hybrid

1000 g of sand was added to the mixing bowl of a commercial Kitchen Aid mixer. In some runs, 2 g of a 5% PEG-DGE (polyethylene glycol diglycidyl ether) solution in ethylene glycol:water (5:95) was then added, followed by mixing for an additional 1 minute at speed setting 2 of the machine (about 70 rpm). In other runs, 1 g of a glycol:water (5:95) mixture was used for this purpose.

A suitable amount, for example, 12.1 g, of a commercially available anionic polyacrylamide inverse emulsion was mixed with a suitable amount, for example, 48.3 g, of a commercially available cationic polyacrylamide inverse emulsion. The mixture so obtained was then added to the mixing bowl containing the previously treated sand, with continued mixing for an additional 3.5 minutes at a speed setting of 2. 2.5 g of a p-MDI covalent crosslinking agent was then added with mixing for an additional 2 minutes at speed setting 2, followed by the addition of 2 g of a 20% aqueous solution of a tertiary amine catalyst for the p-MDI, with mixing for an additional 1.5 minutes at speed setting 2. In all cases the mixture was transferred to a fluid bed dryer and further dried for 7 to 10 minutes at 90° C. and 38 rpm, to obtain a dry, free flowing coated proppant.

Five different self-suspending proppants were made using varying amounts of anionic and cationic polyacrylamide emulsions, keeping all other ingredients the same. In Runs 1, 2, 3 and 5, the anionic polyacrylamides used were hydrolyzed polyacrylamide having different degrees of hydrolysis (charge density) ranging from 10 to 90 mole %, more typically 10 to 60 mole %, 15 to 50 mole %, or even 20 to 40 mole %. Meanwhile, in Run 4 the anionic polyacrylamides used was made by copolymerization of acrylamide and acrylic acid or an acrylic acid salt.

The proppants obtained were then tested using the Settled Bed Height analytical test described above to determine their ability to swell when contacted with the test water described above.

The composition of each proppant tested and the results obtained are shown in the following Table 19:

| | Proppant Composition, wt % (dry), | | | | |
|---|---|---|---|---|---|
| | based on weight of sand substrate | | | | |
| | Run 1 | Run 2 | Run 3 | Run 4 | Run 5 |
| 1st Cationic | 2.46 | 2.05 | 1.85 | 1.54 | 0 |
| Polyacrylamide | | | | | |
| 2nd Cationic | 0 | 0 | 0 | 0 | 2.09 |
| Polyacrylamide | | | | | |
| 1st Anionic | 0.45 | 0.37 | 0 | 0 | 0 |
| Polyacrylamide | | | | | |
| 2nd Anionic | 0 | 0 | 0.72 | 0 | 0 |
| Polyacrylamide | | | | | |
| 3rd Anionic | 0 | 0 | 0 | 1.42 | 0 |
| Polyacrylamide | | | | | |
| 4th Anionic | 0 | 0 | 0 | 0 | 0.57 |
| Polyacrylamide | | | | | |
| Total hydrogel | 2.91 | 2.43 | 2.57 | 2.96 | 2.66 |
| pMDI | 0.25 | 0.25 | 0.25 | 0.25 | 0.25 |
| catalyst | 0.02 | 0.02 | 0.02 | 0.02 | 0.02 |

Performance Testing--Swelling %

| | | | | | |
|---|---|---|---|---|---|
| TW4 | 175 | 145 | 145 | 140 | 125 |
| TW7 | 150 | 130 | 115 | 96 | 125 |

As can be seen from Table 19, the inventive proppants exhibited a significant degree of swelling in different test waters, even though they were made with very small amounts of hydrogel polymer in total. In addition, by comparing Run 4 with the Runs 1, 2, 3 and 5, it can be seen that the inventive self-suspending proppants made with hydrolyzed anionic polyacrylamide exhibit exceptionally good tolerance to waters with very high salt contents.

### Example 12 Anionic PAM/Nonionic Starch

1000 g of 50° C. pre-heated sand was added to the mixing bowl of a commercial Kitchen Aid mixer. In some runs, 2 g of a 5% PEGDGE (polyethylene glycol diglycidyl ether) solution in ethylene glycol:water (5:95) was then added, followed by mixing for an additional 1 minute at speed setting 2 of the machine (about 70 rpm). In other runs, 1 g of a glycol:water (5:95) mixture was used for this purpose.

A suitable amount of the same anionic polyacrylamide inverse emulsion used in Example 8 was added to the mixing bowl, after which a suitable amount of a commercially available nonionic starch, in particular a pre-crosslinked, cold water-swellable modified waxy maize starch, was added and the mixture so obtained mixed for an additional 3.5 minutes at speed setting 2 of the machine. In some runs, the anionic polyacrylamide inverse emulsion contained 10 wt. % glycerol based on the combined weight of the glycerol and emulsion, while in other runs it did not. In addition, in some runs, the pre-crosslinked, cold water-swellable maize starch was added in powder form, as received from the manufacturer, while in other runs it was added in the form of a 60 wt. % dispersion in either IPA (isopropyl alcohol) or a water-white commercially available isoparaffinic organic solvent (IsoparG).

Then 1.25 g of a p-MDI crosslinking agent was added with continuous mixing for 2 minutes at speed setting 2, followed by the addition of 1 g of a 20% aqueous solution of a tertiary amine catalyst for the p-MDI, followed by additional mixing for 1.5 minute at speed setting 2. Various amounts of water were then sprayed into the mixing bowl, following which the mixture was transferred to a fluidized bed dryer and dried for 5 minutes at 90° C. at 38 rpm to obtain a free flowing coated proppant.

Several coatings were made using varying amounts of different components to obtain optimum performance.

The proppants obtained were then tested using the Settled Bed Height analytical test described above to determine their ability to swell when contacted with the test waters. The compositions and the results obtained are shown in the following Table 20:

| | Proppant Comp, wt % (dry), based on weight of sand substrate | | | | | |
|---|---|---|---|---|---|---|
| | Run 1 | Run 2 | Run 3 | Run 4 | Run 5 | Run 6 |
| Pretreat Sand w PEGDE | No | No | Yes | Yes | Yes | No |
| EG in Anionic PAM Emulsion | Yes | Yes | No | No | No | Yes |
| Anionic PAM, wt, % | 1.2 | 1.2 | 1.2 | 1.2 | 1.2 | 1.2 |
| Nonionic starch, wt, % | 3.1 | 3.1 | 3.1 | 3.1 | 3.1 | 3.1 |
| Total Hydrogel, wt. % | 4.3 | 4.3 | 4.3 | 4.3 | 4.3 | 4.3 |
| Form of Nonionic Starch | IPA disp | Iso-G disp | Iso-G disp | IPA disp | powder | IPA disp |
| Amount of Water Spray, g | 12.88 | 12.88 | 12.88 | 12.88 | 13.92 | 12.88 |
| % Swelling, TW 4 | 155 | 120 | 120 | 155 | 125 | 155 |
| % Swelling, TW 7 | 115 | 100 | 100 | 130 | 90 | 105 |

As can be seen from Table 20, the inventive proppants exhibited a significant degree of swelling in different test waters, even though they were made with small amounts of hydrogel polymer in total.

### Example 13 Anionic PAM/Cationic PAM/Nonionic Modified Starch Hybrid

Example 11 was repeated, except that 5-100% wt. % of a nonionic starch, based on the combined weights of the anionic/cationic polyacrylamide mixture used, was also used to make the hydrogel coating of these proppants. In some runs, the nonionic starch was premixed with a mixture of the anionic and cationic polyacrylamide dispersions. In other runs, each of these hydrogel polymers was separately added so that three separate hydrogel coating layers were formed, with the nonionic starch coating layer comprising either the first, second or third coating layer. Also, in some instances, the nonionic modified starch was added in the form of a powder, while in other instances it was added in the form of an aqueous dispersion. In addition, in those instances in which the nonionic modified starch was added in the form of a powder, various amounts of water were then sprayed into the mixing bowl, as described in the above Example 12.

The composition of each proppant tested and the results obtained are shown in the following Table 21:

| | Proppant Composition, wt % (dry), | | | | |
|---|---|---|---|---|---|
| | based on weight of sand substrate | | | | |
| | Run 1 | Run 2 | Run 3 | Run 4 | Run 5 |
| Cationic | 1.51 | 1.51 | 0.95 | 1.51 | 0.95 |
| Polyacrylamide | | | | | |
| Anionic | 0.29 | 0.29 | 0.18 | 0.29 | 0.18 |
| Polyacrylamide | | | | | |
| Nonionic Modified | 0.21 | 0.71 | 2.52 | 0.10 | 2.52 |
| Starch | | | | | |
| Total hydrogel | 2.01 | 2.51 | 3.65 | 1.90 | 3.65 |
| pMDI | 0.12 | 0.12 | 0.12 | 0.12 | 0.12 |
| catalyst | 0.02 | 0.02 | 0.02 | 0.02 | 0.02 |
| Form of Starch | Powder | Powder | Powder | Aq. disp. | Powder |
| Amount of Water | 1.65 | 5.51 | 9.84 | 0 | 9.84 |
| Spray, g | | | | | |

Performance Testing--Swelling %

| | | | | | |
|---|---|---|---|---|---|
| Swelling % in TW4 | 125 | 125 | 115 | 140 | 110 |
| Swelling % in TW7 | 110 | 110 | 105 | 110 | 105 |

As can be seen from Table 21, the inventive proppants exhibited a significant degree of swelling in different test waters, even though they were made with relatively small amounts of hydrogel polymer in total.

### Example 14 Cationic PAM/Nonionic Modified Starch Hybrid

Example 8 was repeated except that a commercially available cationic polyacrylamide inverse emulsion containing approximately one third polymer, one third organic solvent and one third water was used to form the first coating on the sand substrate particles, while an aqueous dispersion of a commercially available nonionic modified starch was used to form the second hydrogel polymer coating in some runs (Run 2 through Run 4), while another nonionic modified starch aqueous dispersion or powder was used to form the second hydrogel layer in other runs (Run 5 through Run 7). In those instances in which a nonionic modified nonionic starch in powder form was used, the powder was added after the first coating or was mixed with the cationic hydrogel polymer first and then coated onto substrate. One experiment was also carried out without any nonionic starch coating (Run 1).

The composition of each proppant tested and the results obtained are shown in the following Table 22:

| | Proppant Composition, wt % (dry), based on weight of sand substrate | | | | | | |
|---|---|---|---|---|---|---|---|
| | Run 1 | Run 2 | Run 3 | Run 4 | Run 5 | Run 6 | Run 7 |
| Cationic Polyacrylamide | 2.3 | 2.3 | 2.6 | 2.6 | 2.3 | 2.6 | 2.6 |
| Nonionic modified starch | 0 | 1.6 | 2.3 | 3.3 | 0.21 | 1.5 | 2.4 |
| Total hydrogel | 2.3 | 3.9 | 4.9 | 5.9 | 2.51 | 4.1 | 5.0 |
| PPGDGE | 0 | 0.68 | 0.68 | 0.68 | 0 | 0 | 0 |
| NaOH (5M) | 0 | 1 | 1 | 1 | 0 | 0 | 0 |
| pMDI | 0.25 | 0.25 | 0.25 | 0.25 | 0.25 | 0.25 | 0.25 |
| Catalyst | 0.02 | 0.02 | 0.02 | 0.02 | 0.02 | 0.02 | 0.02 |
| Form of the Starch | N/A | disp | disp. | disp. | Powder | Powder | disp. |

Performance Testing--Swelling %

| | | | | | | | |
|---|---|---|---|---|---|---|---|
| TW 4 | 160 | 85 | 100 | 120 | 130 | 140 | 160 |
| TW 7 | 130 | 75 | 90 | 110 | 120 | 130 | 150 |

As can be seen from Table 8, all of the inventive proppants exhibited varying degrees of swelling in different test waters, even though they were also made with comparatively little amounts of hydrogel polymer in total.

Although only a few embodiments of this invention have been described above, it should be appreciated that many modifications can be made without departing from the spirit and scope of the invention. All such modifications are intended to be included within the scope of this invention, which is to be limited only by the following claims.

1. A process for fracturing a subterranean geological formation comprising introducing into the formation an aqueous fracturing fluid containing an aqueous carrier liquid and a modified proppant comprising a proppant substrate particle and a hydrogel polymer coating on the proppant substrate particle, wherein the hydrogel polymer coating comprises the combination of a cationic polyacrylamide polymer and an anionic polyacrylamide polymer, and further wherein prior to reaching its final destination downhole the modified proppant is exposed to a level of water hardness which is sufficient to adversely affect the ability of said anionic polyacrylamide polymer to swell.

2. The process of claim 1, wherein prior to reaching its final destination downhole the modified proppant is exposed to a level of water hardness of at least 300 ppm.

3. The process of claim 2, wherein the aqueous carrier liquid from which the aqueous fracturing fluid is made has a level of water hardness of at least 300 ppm.

4. The process of claim 2, wherein the modified proppant encounters geological formation water prior to reaching its final destination downhole, and further wherein the geological formation water has a level of water hardness of at least 300 ppm.

5. The process of claim 2, wherein the hydrogel polymer coating comprises about 70 to 90 wt. % cationic polyacrylamide polymer and about 10 to 30 wt. % anionic polyacrylamide polymer.

6. The process of claim 5, wherein the modified proppant is made by (a) forming a premix of a cationic polyacrylamide polymer invert emulsion and an anionic polyacrylamide polymer invert emulsion, (b) combining the premix so formed with the proppant substrate particle with mixing, thereby forming a polymer/particle mixture, (c) continuing to mix the polymer/particle mixture until the hydrogel polymer coating is formed, and (d) drying the hydrogel polymer coating.

7. The process of claim 6, wherein the hydrogel polymer coating is crosslinked by means of a covalent crosslinking agent.

8. The process of claim 7, wherein the proppant substrate particle is coated with a first covalent crosslinking agent before the polymer/particle mixture is formed and further wherein a second covalent crosslinking agent is combined with the polymer/particle mixture before the hydrogel polymer coating is dried.

9. The process of claim 5, wherein the hydrogel polymer coating is made by (a) combining the proppant substrate particle with a cationic polyacrylamide polymer invert emulsion to form a first polymer/particle mixture, (b) combining the first polymer/particle mixture so formed with an anionic polyacrylamide polymer invert emulsion to form a second polymer/particle mixture, (c) continuing to mix the second polymer/particle mixture until the hydrogel polymer coating is formed, and (d) drying the hydrogel polymer coating.

10. The process of claim 9, wherein the hydrogel polymer coating is crosslinked by means of a covalent crosslinking agent.

11. The process of claim 10, wherein the proppant substrate particle is coated with a first covalent crosslinking agent before the first polymer/particle mixture is formed and further wherein a second covalent crosslinking agent is combined with the second polymer/particle mixture before the hydrogel polymer coating is dried.

12. The process of claim 5, wherein the hydrogel polymer coating is made by (a) combining the proppant substrate particle with an anionic polyacrylamide polymer invert emulsion to form a first polymer/particle mixture, (b) combining the first polymer/particle mixture so formed with cationic polyacrylamide polymer invert emulsion to form a second polymer/particle mixture, (c) continuing to mix the second polymer/particle mixture until the hydrogel polymer coating is formed, and (d) drying the hydrogel polymer coating.

13. The process of claim 12, wherein the hydrogel polymer coating is crosslinked by means of a covalent crosslinking agent.

14. The process of claim 13, wherein the proppant substrate particle is coated with a first covalent crosslinking agent before the first polymer/particle mixture is formed and further wherein a second covalent crosslinking agent is combined with the second polymer/particle mixture before the hydrogel polymer coating is dried.

15. The process of claim 5, wherein the modified proppant exhibits a volumetric expansion of at least about 1.3 after having been subjected to shear mixing in a simulated hard water containing 6,400 ppm hardness at a shear rate of about 511 s⁻¹ for 10 minutes.

16. A process for fracturing a subterranean geological formation comprising introducing into the formation an aqueous fracturing fluid containing an aqueous carrier liquid and a modified proppant comprising a proppant substrate particle and a hydrogel polymer coating on the proppant substrate particle, wherein the hydrogel polymer coating comprises the combination of a starch and either a cationic polyacrylamide polymer or an anionic hydrogel polymer, and further wherein prior to reaching its final destination downhole the modified proppant is exposed to a level of water hardness which is sufficient to adversely affect the ability of said anionic hydrogel polymer to swell.

17. The process of claim 16, wherein prior to reaching its final destination downhole the modified proppant is exposed to a level of water hardness of at least 300 ppm.

18. The process of claim 17, wherein the aqueous carrier liquid from which the aqueous fracturing fluid is made has a level of water hardness of at least 300 ppm.

19. The process of claim 18, wherein the modified proppant encounters geological formation water prior to reaching its final destination downhole, and further wherein the geological formation water has a level of water hardness of at least 300 ppm.

20. The process of claim 16, wherein the hydrogel polymer coating comprises the combination of a nonionic starch and a cationic polyacrylamide polymer.

21. The process of claim 16, wherein the hydrogel polymer coating comprises the combination of a hydrolyzed starch and an anionic hydrogel polymer.

22. The process of claim 16, wherein the modified proppant exhibits a volumetric expansion of at least about 1.3 after having been subjected to shear mixing in a simulated hard water containing 6,400 ppm hardness at a shear rate of about 511 s⁻¹ for 10 minutes.

23. A modified proppant comprising a proppant substrate particle and a hydrogel polymer coating on the proppant substrate particle, wherein the hydrogel polymer coating comprises the combination of a starch and either a cationic polyacrylamide polymer or an anionic hydrogel polymer.

24. The modified proppant of claim 23, wherein the hydrogel polymer coating comprises the combination of a nonionic starch and a cationic polyacrylamide polymer.

25. The modified proppant of claim 23, wherein the hydrogel polymer coating comprises the combination of a hydrolyzed starch and an anionic hydrogel polymer.

26. The modified proppant of claim 23, wherein the hydrogel polymer coating is crosslinked by means of a covalent crosslinking agent.

27. The modified proppant of claim 23, wherein the modified proppant exhibits a volumetric expansion of at least about 1.3 after having been subjected to shear mixing in a simulated hard water containing 6,400 ppm hardness at a shear rate of about 511 s⁻¹ for 10 minutes.

28. A process for fracturing a subterranean geological formation comprising introducing into the formation an aqueous fracturing fluid containing an aqueous carrier liquid and a modified proppant comprising a proppant substrate particle and a hydrogel polymer coating on the proppant substrate particle, wherein the hydrogel polymer coating comprises the combination of a cationic polyacrylamide polymer or an anionic polyacrylamide polymer, wherein the amount of the anionic polymer to total polymer is less than about 50 wt % on a dry weight basis, the amount of the cationic polymer to total polymer is at least about 50% wt % on a dry weight basis and the hydrogel polymer coating is crosslinked by means of a covalent crosslinking agent.

29. The process of claim 28, wherein the aqueous carrier liquid from which the aqueous fracturing fluid is made has a level of water hardness of at least 300 ppm.

30. The process of claim 28, wherein the hydrogel polymer coating is made by (a) combining the proppant substrate particle with a cationic polyacrylamide polymer invert emulsion to form a first polymer/particle mixture, (b) combining the first polymer/particle mixture so formed with an anionic polyacrylamide polymer invert emulsion to form a second polymer/particle mixture, (c) continuing to mix the second polymer/particle mixture until the hydrogel polymer coating is formed, (d) adding a covalent crosslinking agent and (e) drying the hydrogel polymer coating.

31. The process of claim 28 wherein the covalent crosslinking agent is polymeric methylenediphenyldiisocyanate.

32. The process of claim 28 wherein the amount of the anionic polymer to total polymer is less than about 30 wt % on a dry weight basis, the amount of the cationic polymer to total polymer is at least about 70% wt % on a dry weight basis.

33. The process of claim 30 wherein the proppant substrate is pretreated with a solution of polyethylenediglycidyl ether prior to combining the particle with a cationic polyacrylamide polymer invert emulsion.
